(19) United States
(12) Patent Application Publication
(10) Pub. No.: US 2025/0020501 A1
(43) Pub. Date: Jan. 16, 2025

(54) CALIBRATED VIRTUAL FLOW METER

(71) Applicant: Schlumberger Technology Corporation, Sugar Land, TX (US)

(72) Inventors: Agustin Gambaretto, Houston, TX (US); Kashif Rashid, Cambridge, MA (US); Michael John Williams, Cambridge (GB)

(21) Appl. No.: 18/706,764

(22) PCT Filed: Nov. 15, 2022
(86) PCT No.: PCT/US2022/049885

§ 371 Date: May 2, 2024

Related U.S. Application Data
(60) Provisional application No. 63/279,832, filed on Nov. 16, 2021.

(51) Int. Cl. G01F 25/10; G01F 1/34; G01F 1/74; G01F 15/00

(52) U.S. Cl. CPC G01F 25/10; G01F 1/34; G01F 1/74; G01F 15/005

(57) ABSTRACT

A method can include calibrating a model using pressure and flow rate data to generate a calibrated model; receiving an upstream pressure value and a downstream pressure value that define a pressure differential across a flow device; and computing a flow rate through the flow device using the upstream pressure value, the downstream pressure value and the calibrated model.

### CROSS-REFERENCE TO RELATED APPLICATION(S)

The subject disclosure claims priority from U.S. Provisional Appl. No. 63/279,832, filed on Nov. 16, 2021, herein incorporated by reference in its entirety.

### BACKGROUND

Various techniques can be utilized for artificial-lift, which can, for example, help to produce fluid from a reservoir, etc. Gas-lift is a type of artificial-lift where, for example, gas can be injected into production tubing to reduce hydrostatic pressure of a fluid column. In such an approach a resulting reduction in bottomhole pressure can allow reservoir fluid to enter a wellbore at a higher flow rate. In various instances, injection gas can be conveyed down a tubing-casing annulus and enter a production train through one or more gas-lift valves.

### SUMMARY

A method can include calibrating a model using pressure and flow rate data to generate a calibrated model; receiving an upstream pressure value and a downstream pressure value that define a pressure differential across a flow device; and computing a flow rate through the flow device using the upstream pressure value, the downstream pressure value and the calibrated model. A system can include one or more processors; memory accessible to at least one of the one or more processors; processor-executable instructions stored in the memory and executable to instruct the system to: calibrate a model using pressure and flow rate data to generate a calibrated model; receive an upstream pressure value and a downstream pressure value that define a pressure differential across a flow device; and compute a flow rate through the flow device using the upstream pressure value, the downstream pressure value and the calibrated model. One or more computer-readable storage media can include processor-executable instructions to instruct a computing system to: calibrate a model using pressure and flow rate data to generate a calibrated model; receive an upstream pressure value and a downstream pressure value that define a pressure differential across a flow device; and compute a flow rate through the flow device using the upstream pressure value, the downstream pressure value and the calibrated model. A system can include a controller that outputs a signal for adjustment of a valve upstream a flow device; a pressure measurement interface that receives an upstream pressure value from a pressure gauge upstream the flow device and a downstream pressure value from a pressure gauge downstream the flow device; and a calibrated model that computes liquid flow rate through the flow device based on the upstream pressure value and the downstream pressure value, where the controller outputs the signal based at least in part on the liquid flow rate. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system;

FIG. 2 illustrates an example of a system and an example of a method;

FIG. 3 illustrates an example of a system;

FIG. 4 illustrates an example of a gas lift valve;

FIGS. 5A and 5B illustrate the gas lift valve of FIG. 4;

FIG. 6 illustrates an example of a flow device;

FIG. 7 illustrates an example of a system;

FIG. 8 illustrates an example of a system;

FIG. 9 illustrates an example of a system and example plots;

FIG. 10 illustrates an example of a system;

FIG. 11 illustrates an example of a system;

FIG. 12 illustrates examples of calibration processes;

FIG. 13 illustrates an example of a system;

FIG. 14 illustrates examples of plots;

FIG. 15 illustrates examples of plots;

FIG. 16 illustrates examples of plots;

FIG. 17 illustrates examples of plots;

FIG. 18 illustrates examples of plots;

FIG. 19 illustrates an example of a system;

FIG. 20 illustrates an example of a method;

FIG. 21 illustrates an example of a controller;

FIG. 22 illustrates an example of a controller;

FIG. 23 illustrates examples of computer and network equipment; and

FIG. 24 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

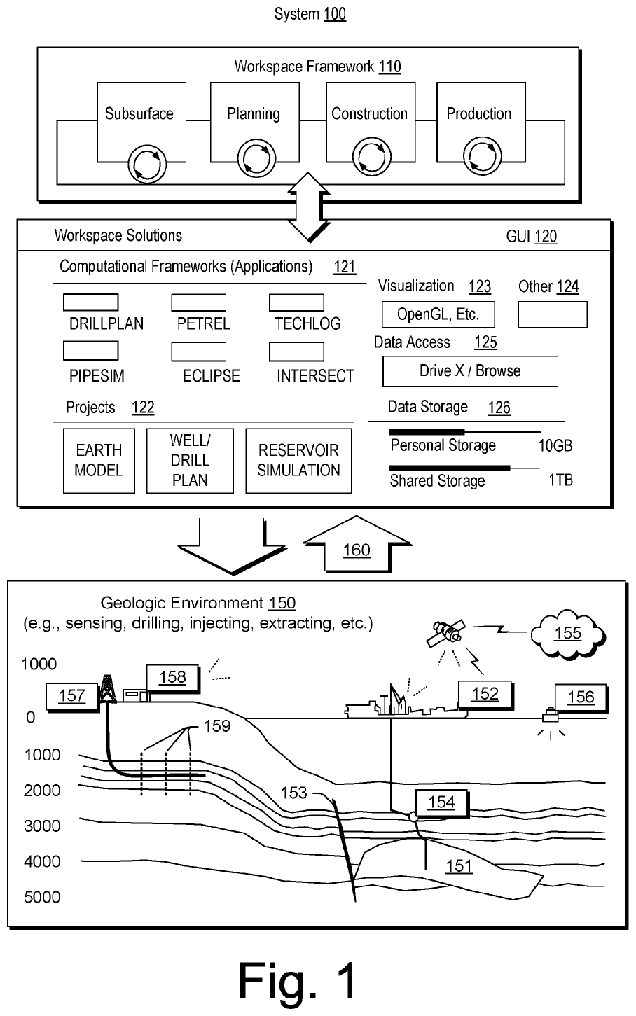

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows various features of a computational environment that can include various features of the DELFI environment, which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework is part of the DELFI cognitive E & P environment (Schlumberger Limited, Houston, Texas) for utilization in geosciences and geoengineering, for example, to analyze subsurface data from exploration, to development, to drilling, to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E & P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G & G”) service provider, which may generate a well trajectory, which may involve execution of one or more G & G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where later acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.). While several simulators are illustrated in the example of FIG. 1, one or more other simulators may be utilized, additionally or alternatively.

As mentioned, a framework may be implemented within or in a manner operatively coupled to the DELFI cognitive exploration and production (E & P) environment (Schlumberger, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

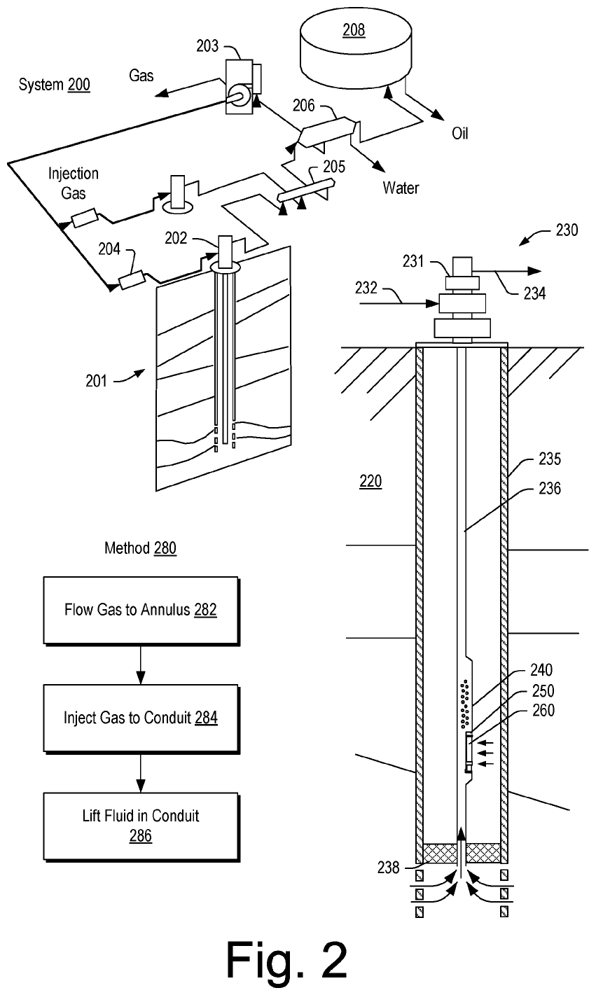

FIG. 2 shows an example of a system 200 that includes various types of equipment. As an example, the system 200 may be planned, modeled, controlled, etc., using one or more features of the system 100 of FIG. 1. For example, consider reservoir modeling where production of fluid, injection of fluid, etc., may be modeled, simulated, etc. As an example, production may decrease with respect to time for one or more wells where an artificial-lift strategy may be implemented to increase, maintain, etc., production, optionally in combination with one or more other strategies (e.g., flooding, treatment, stimulation, fracturing, etc.). As an example, the system 100 may provide estimates as to gas production where such gas may be utilized in one or more artificial-lift operations. As an example, where at least some equipment may scale and/or affect a scaling mechanism, such phenomena may be modeled, simulated, controlled, etc. For example, gas lift equipment may experience scale formation and, for example, may alter one or more of pressure, temperature, chemistry, phase dynamics, etc. A system such as the system 100 of FIG. 1 may provide for combined strategies that aim to optimize artificial lift, which may include one or more strategies as to gas production, scale mitigation, scale treatment, etc.

Gas lift (or gas-lift) is a process where, for example, gas may be injected from an annulus into tubing. An annulus, as applied to an oil well or other well for recovering a subsurface resource may refer to a space, lumen, or void between piping, tubing or casing and the piping, tubing, or casing immediately surrounding it, for example, at a greater radius.

As an example, injected gas may aerate well fluid in production tubing in a manner that “lightens” the well fluid such that the fluid can flow more readily to a surface location. As an example, one or more gas lift valves may be configured to control flow of gas during an intermittent flow or a continuous flow gas lift operation. As an example, a gas lift valve may operate based at least in part on a differential pressure control that can actuate a valve mechanism of the gas lift valve.

As gas lift valve may include a so-called hydrostatic pressure chamber that, for example, may be charged with a desired pressure of gas (e.g., nitrogen, etc.). As an example, an injection-pressure-operated (IPO) gas lift valve or an unloading valve can be configured so that an upper valve in a production string opens before a lower valve in the production string opens.

As an example, a gas lift valve may be configured, for example, in conjunction with a mandrel, for placement and/or retrieval of the gas lift valve using a tool. For example, consider a side pocket mandrel that is shaped to allow for installation of one or more components at least partially in a side pocket or side pockets where a production flow path through the side pocket mandrel may provide for access to a wellbore and completion components located below the side pocket mandrel. As an example, a side pocket mandrel can include a main axis and a pocket axis where the pocket axis is offset a radial distance from the main axis. In such an example, the main axis may be aligned with production tubing, for example, above and/or below the side pocket mandrel.

As an example, a tool may include an axial length from which a portion of the tool may be kicked-over (e.g., to a kicked-over position). In such an example, the tool may include a region that can carry a component such as a gas lift valve. An installation process may include inserting a length of the kickover tool into a side pocket mandrel (e.g., along a main axis) and kicking over a portion of the tool that carries a component toward the side pocket of the mandrel to thereby facilitate installation of the component in the side pocket. A removal process may operate in a similar manner, however, where the portion of the tool is kicked-over to facilitate latching to a component in a side pocket of a side pocket mandrel.

Where gas lift equipment is damaged by scale, one or more remedial operations may be performed; whereas, if left unmitigated, fluid production may decrease and it may be difficult to implement one or more tools (e.g., kickover tool, etc.).

In FIG. 2, the system 200 is shown with an example of a geologic environment 220 that includes equipment and an example of a method 280. The system 200 includes a subterranean formation 201 with a well 202. Injection gas is provided to the well 202 via a compressor 203 and a regulator 204. The injection gas can assist with lifting fluid that flows from the subterranean formation 201 to the well 202. The lifted fluid, including injected gas, may flow to a manifold 205, for example, where fluid from a number of wells may be combined. As shown in the example of FIG. 2, the manifold 205 is operatively coupled to a separator 206, which may separate components of the fluid. For example, the separator 206 may separate oil, water and gas components as substantially separate phases of a multiphase fluid. In such an example, oil may be directed to an oil storage facility 208 while gas may be directed to the compressor 203, for example, for re-injection, storage and/or transport to another location. As an example, water may be directed to a water discharge, a water storage facility, etc.

As shown in FIG. 2, the geologic environment 220 is fitted with well equipment 230, which includes a well-head 231 (e.g., a Christmas tree, etc.), an inlet conduit 232 for flow of compressed gas, an outlet conduit 234 for flow of produced fluid, a casing 235, a production conduit 236, and a packer 238 that forms a seal between the casing 235 and the production conduit 236. As shown, fluid may enter the casing 235 (e.g., via perforations) and then enter a lumen of the production conduit 236, for example, due to a pressure differential between the fluid in the subterranean geologic environment 220 and the lumen of the production conduit 236 at an opening of the production conduit 236. Where the inlet conduit 232 for flow of compressed gas is used to flow gas to the annular space between the casing 235 and the production conduit 236, a mandrel 240 operatively coupled to the production conduit 236 that includes a pocket 250 that seats a gas lift valve 260 that may regulate the introduction of the compressed gas into the lumen of the production conduit 236. In such an example, the compressed gas introduced may facilitate flow of fluid upwardly to the well-head 231 (e.g., opposite a direction of gravity) where the fluid may be directed away from the well-head 231 via the outlet conduit 234.

As shown in FIG. 2, the method 280 can include a flow block 282 for flowing gas to an annulus (e.g., or, more generally, a space exterior to a production conduit fitted with a gas lift valve), an injection block 284 for injecting gas from the annulus into a production conduit via a gas lift valve or gas lift valves and a lift block 286 for lifting fluid in the production conduit due in part to buoyancy imparted by the injected gas.

As an example, where a gas lift valve includes one or more actuators, such actuators may optionally be utilized to control, at least in part, operation of a gas lift valve (e.g., one or more valve members of a gas lift valve). As an example, surface equipment can include one or more control lines that may be operatively coupled to a gas lift valve or gas lift valves, for example, where a gas lift valve may respond to a control signal or signals via the one or more control lines. As an example, surface equipment can include one or more power lines that may be operatively coupled to a gas lift valve or gas lift valves, for example, where a gas lift valve may respond to power delivered via the one or more power lines. As an example, a system can include one or more control lines and one or more power lines where, for example, a line may be a control line, a power line or a control and power line.

As an example, a production process may optionally utilize one or more fluid pumps such as, for example, an electric submersible pump (e.g., consider a centrifugal pump, a rod pump, etc.). As an example, a production process may implement one or more so-called “artificial lift” (or artificial-lift) technologies. An artificial lift technology may operate by adding energy to fluid, for example, to initiate, enhance, etc. production of fluid.

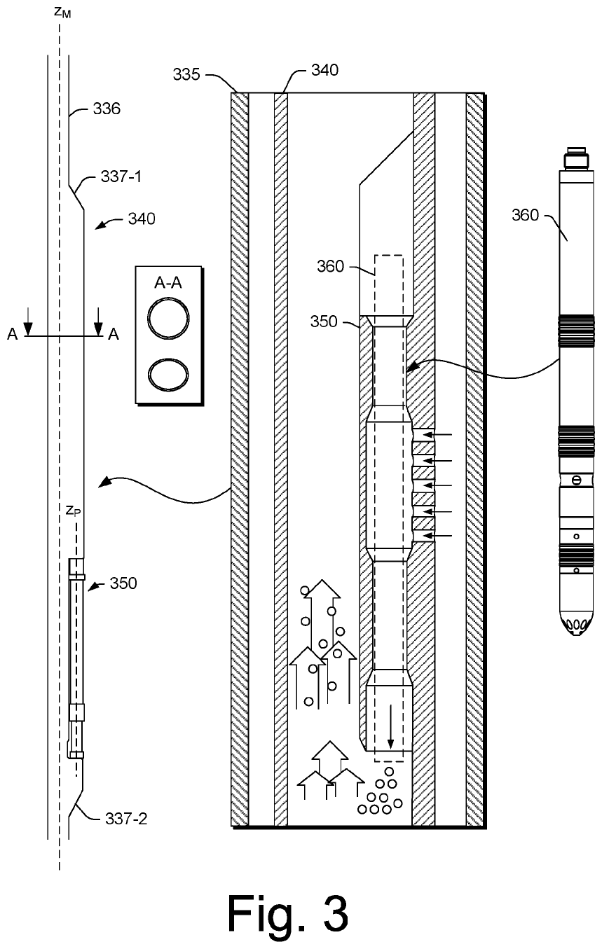

FIG. 3 shows an example of a system 300 that includes a casing 335, a production conduit 336 and a mandrel 340 that includes a pocket 350 that seats a gas lift valve 360. As shown, the mandrel 340 can include a main longitudinal axis (z_{M}) and a side pocket longitudinal axis (z_{P}) that is offset a radial distance from the main longitudinal axis (z_{M}). In the example of FIG. 3, the axes (z_{M} and z_{P}) are shown as being substantially parallel such that a bore of the pocket 350 is parallel to a lumen of the mandrel 340. Also shown in FIG. 3 are two examples of cross-sectional profiles for the mandrel 340, for example, along a line A-A. As shown, a mandrel may include a circular cross-sectional profile or another shaped profile such as, for example, an oval profile.

As an example, a completion may include multiple instances of the mandrel 340, for example, where each pocket of each instance may include a gas lift valve where, for example, one or more of the gas lift valves may differ in one or more characteristics from one or more other of the gas lift valves (e.g., pressure settings, etc.).

As shown in the example of FIG. 3, the mandrel 340 can include one or more openings that provide for fluid communication with fluid in an annulus (e.g., gas and/or other fluid), defined by an outer surface of the mandrel 340 and an inner surface of the casing 335, via a gas lift valve 360 disposed in the pocket 350. For example, the gas lift valve 360 may be disposed in the pocket 350 where a portion of the gas lift valve 360 is in fluid communication with an annulus (e.g., with casing fluid) and where a portion of the gas lift valve 360 is in fluid communication with a lumen (e.g., with tubing fluid). In such an example, fluid may flow from the annulus to the lumen (e.g., bore) to assist with lift of fluid in the lumen or, for example, fluid may flow from the lumen to the annulus. The pocket 350 may include an opening that may be oriented downhole and one or more openings that may be oriented in a pocket wall, for example, directed radially to a lumen space. As an example, the pocket 350 may include a production conduit lumen side opening (e.g., an axial opening) for placement, retrieval, replacement, adjustment, etc. of a gas lift valve. For example, through use of a tool, the gas lift valve 360 may be accessed. As an example, where a gas lift valve includes circuitry such as a battery or batteries, a tool may optionally provide for charging and/or replacement of a battery or batteries.

In the example of FIG. 3, gas is illustrated as entering from the annulus to the gas lift valve 360 as disposed in the pocket 350. Such gas can exit at a downhole end of the gas lift valve 360 where the gas can assist in lifting fluid in the lumen of the mandrel 340 (e.g., as supplied via a bore of production tubing, etc.).

As an example, a side pocket mandrel may include a circular and/or an oval cross-sectional profile (e.g., or other shaped profile). As an example, a side pocket mandrel may include an exhaust port (e.g., at a downhole end of a side pocket).

As an example, a mandrel may be fit with a gas lift valve that may be, for example, a valve according to one or more specifications such as an injection pressure-operated (IPO) valve specification. As an example, a positive-sealing check valve may be used such as a valve qualified to meet API-19G1 and G2 industry standards and pressure barrier qualifications. For example, with a test pressure rating of about 10,000 psi (e.g., about 69,000 kPa), a valve may form a metal-to-metal barrier between production tubing and a casing annulus that may help to avoid undesired communication (e.g., or reverse flow) and to help mitigate risks associated with gas lift valve check systems.

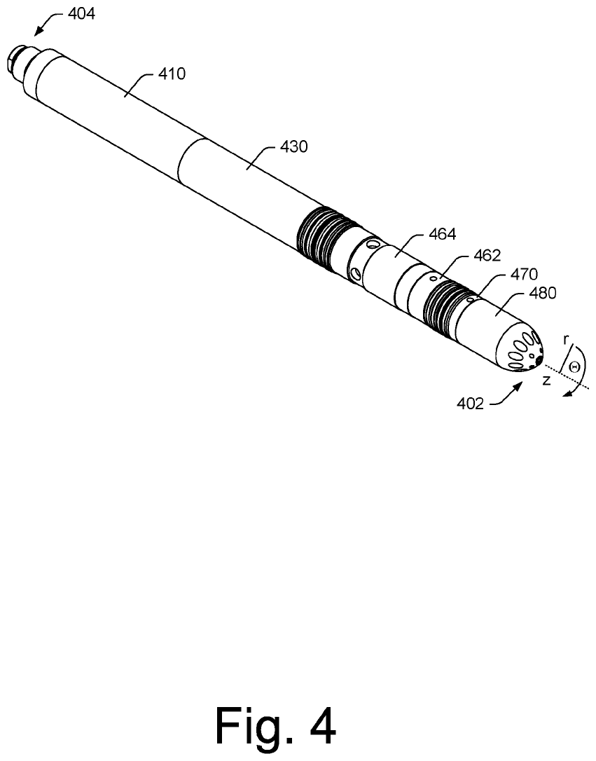

FIG. 4 shows an example of a gas lift valve 400 that includes a gas outlet end 402, a tool end 404, a control gas chamber section 410, a bellows valve mechanism section 430, a coupling 462, a gas inlet section 464, a coupling 470 and a gas outlet section 480. Various features of the gas lift valve 400 may be described with respect to a cylindrical coordinate system (e.g., r, z, Θ) where, for example, a z-axis represents a longitudinal axis of the gas lift valve 400, a r-axis represents a distance from the z-axis (e.g., radially outwardly) and an azimuthal angle (Q) represents an azimuthal position of a feature, for example, with respect to a feature that may be deemed to be at 0 degrees (e.g., a reference feature such as an opening, etc.).

In the example of FIG. 4, the gas lift valve 400 can include a plurality of seal elements, for example, to seal against a bore of a mandrel in which at least a portion of the gas lift valve 400 may be disposed. As an example, a seal element or seal elements may act to form a seal between an outer surface of a gas lift valve and an inner surface of a bore of a mandrel where such a seal may be disposed between a gas inlet opening and a gas outlet opening of the gas lift valve. As an example, seal elements may be ring shaped and, for example, at least in part seated in one or more annular grooves of an outer surface of a gas lift valve. As an example, a gas lift valve can include a plurality of internal seal elements.

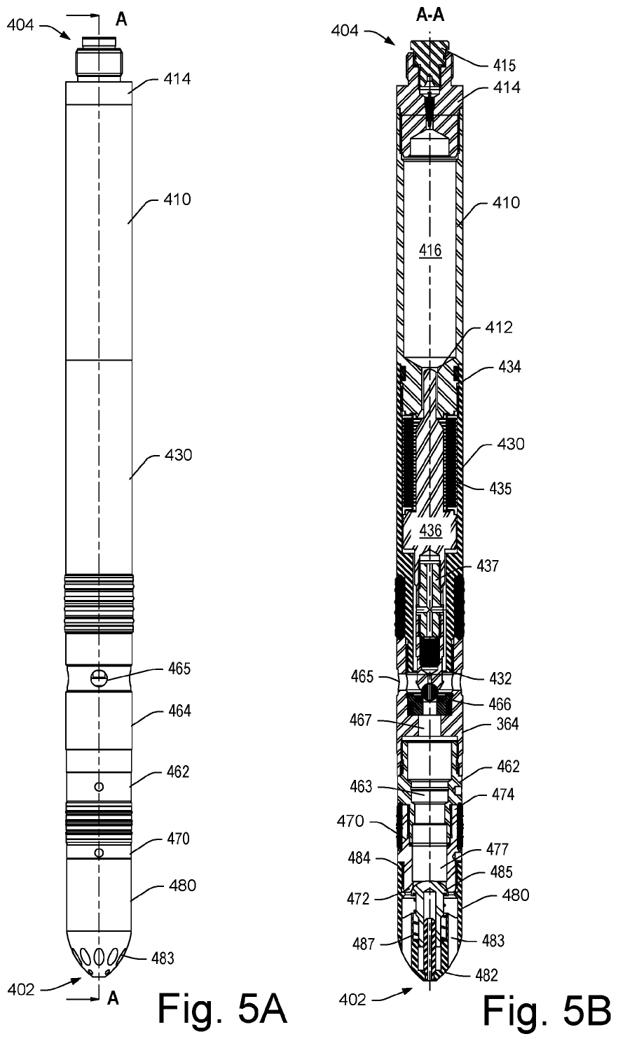

FIG. 5A shows a side view of the gas lift valve 400 and FIG. 5B shows a cutaway view of the gas lift valve 400 along a line A-A. As shown in FIG. 5A, the gas inlet section 464 includes at least one opening 465 as a gas inlet (see, e.g., the arrangement of FIG. 3) and the gas outlet section 480 includes at least one opening 483 as a gas outlet.

FIG. 5B shows the control gas chamber section 410 as including a piston bore 412 and a plug 414 at opposing ends of a gas chamber 416, which may be charged with gas such as nitrogen. In the example of FIG. 5B, a seal plug 415 may be utilized to seal a passage in the plug 414, for example, after charging the gas chamber 416 to a desired gas pressure.

FIG. 5B shows the bellows valve mechanism section 430 as including opposing ends 432 and 434, a bellows 435, a piston 436 and a valve member 437. In the example of FIG. 4B, the bellows 435 may be sealed with respect to the bellows 435 and the chamber 416. In such an example, the one or more openings 465 of the gas inlet section 464 can communicate gas pressure that can act upon the valve member 437. In such an example, where the pressure is sufficiently high (e.g., with respect to pressure in the chamber 416), force exerted may cause the valve member 437 and the piston 436 to translate toward the chamber 416. In such an example, the valve member 437 may retract from a valve seat 466 that is supported by the gas inlet section 464. As shown, the valve seat 466 is annular such that an opening defined thereby can allow for flow of gas to a bore 467 of the gas inlet section 464.

In the example of FIG. 5B, the coupling 462 includes a bore 463 that is in fluid communication with the bore 467 and that is in fluid communication with a bore 477 of the coupling 470 such that gas pressure can act upon a check valve member 485 supported by the gas outlet section 480, which may be seated against an end 472 of the coupling 470, which has an opposing end 474. For example, the check valve member 485 may include a translatable dome shape that can seat against an annular check valve seat defined by the end 472 of the coupling 470.

In the example of FIG. 5B, the check valve member 485 can be biased by a biasing member 487, which may be, for example, a spring. Where gas pressure in the bore 477 of the coupling 470 is sufficiently high, force acting on the check valve member 485 may cause compression of the biasing member 487 and translation of the check valve member 485 downwardly away from the gas inlet section 464 such that the one or more openings 465 of the gas inlet section 464 become in fluid communication with the one or more openings 483 of the gas outlet section 480.

As an example, the check valve member 485 may be referred to as a dart. As an example, the check valve member 485 may be considered to be a low pressure valve member; whereas, the valve member 437 may be considered to be a high pressure valve member. As an example, a valve member can include a ball that can be seated in a valve seat to plug an opening in the valve seat.

As explained, fluid can flow in various types of equipment, which may include one or more fluid passages, which may range in a cross-section dimension from 0.1 cm to 30 cm (e.g., consider a diameter of 0.1 cm to a diameter of 30 cm). Scale formation in a fluid passage can be detrimental to one or more operations, which may include equipment operation (e.g., gas lift valve, etc.) to production operation (e.g., production of hydrocarbons, etc.). Scale buildup can render equipment inoperable and costly to remediate or remove. As mentioned, scale building in side-pocket mandrel can be detrimental, where scale formed may diminish cross-section of a passage (e.g., a tool passage, a fluid passage, etc.). In various instances, one or more operations may be performed that aim to mitigate scale, treat scale, etc.

As an example, a method can provide a robust data-driven approach for continuous gas lift optimization where a well response can be noisy (e.g., include noise). Such a method may be for one or more wells where, for example, available gas may be taken into account (e.g., an available gas limit). Such a method can provide for improved gas lift optimization in presence of a noisy response to provide for appropriate resource allocations, for example, with respect to one or more expected values. As an example, a method may optionally account for one or more phenomena such as scaling, equipment wear, etc. For example, output from an optimization method may be integrated into a more expansive plan for field operations.

As an example, a method can operate according to constraints and a control scheme or schemes where field data as acquired by one or more sensors may be utilized. As an example, a method may be applied to a single well or may be applied to multiple wells (e.g., a multi-well method). Various trials results are presented, for example, for a single well with noise and excess gas, multiple wells with noise and excess gas, multiple wells with noise and a gas limit, multiple wells without noise and excess gas and multiple wells without noise and a gas limit.

As an example, a method can be or include a control scheme that can handle noisy well responses with consideration of changing well behavior with time. As explained further below, a method can handle various two-well cases with excess or limited lift-gas with either noisy or smooth underlying representative gas lift performance curves. Various trial results demonstrate the efficacy of various example methods in handling noisy responses over multiple wells, for example, with an aim to maximize long-term expected value of production (e.g., in place of a single optimum that may be hard to attain).

As an example, a sequence of polynomial representations may be constructed for a single noisy well or for multiple noisy wells. In such an example, a resulting distribution of solution set points can be derived. Such a method can aim to maximize the long-term expected value of the well response.

Continuous gas lift optimization concerns the distribution of lift gas over one or more wells. Allocated gas can be injected at high pressure into the annulus of a wellbore, which can facilitate lifting fluid upwardly, for example, where increased gas quantity in the wellbore can reduce pressure exerted by a column of fluid. Such phenomena can lower the bottom-hole pressure and assists in pushing more fluids to the surface. Often, each well has a desirable lift gas-rate that improves well production, beyond which the production rate is impaired by the increased frictional losses resulting from excessive gas injection. Gas lift can be characterized using a gas lift performance curve (GLPC).

Gas lift optimization thus concerns the optimal distribution of available lift-gas under specified operational constraints so as to maximize the value of the produced hydrocarbons over all wells. Two approaches used to tackle this problem can be categorized as either simulation model-based or model-free.

In a simulation-based approach, each well may be modeled using data concerning trajectory, dimensions, fluid properties, reservoir pressure, temperature and other pertinent information, including the surface network connecting the wells. The simulation model can then be optimized to provide the gas lift rates that maximize the total value subject to operational constraints, including those that dictate flow assurance by prevention of hydrate, wax or asphaltene formation, in one step.

In a data driven (model-free) approach, pertinent data gathered directly at the well-site that describes the production value of each well as a function of gas lift injection is used to provision information that can be applied to a controller to furnish a new set point over all wells. Such an approach can proceed without simulation model construction, validation or maintenance and without modeling assumptions where errors are not introduced.

The data driven (model-free) approach has the advantage of providing a predictive response that can be used for optimization purposes directly in conjunction with a suitable solver. The model-free approach can involve a sequence of iterates, that step towards system optimality. Thus, the simulation-based approach requires time and effort to develop a reliable simulation model, while the data driven (model free) approach demands time to physically iterate the real-system towards optimality in closed-loop.

Simple curve-based representations, nodal analysis or detailed simulation responses may be used to solve a continuous gas lift optimization problem. However, in these model-based schemes, the implicit assumption is that the representative GLPC is smooth and well-behaved. In a model-free approach, real-time data is gathered from multi-phase flow meters. The data are noisy and prone to variation due to several complicating factors. These include the set-point control (which is often specified in a band of the setting), data acquisition (compounded by hardware and sensor noise), data quality (processing and filtering methods), well stability (inherent dynamics due to flow regime, interdependent wells and back-pressure effects imposed by connected pipelines), equipment failure (downtime in compression and data acquisition), among others. The net result is the well response is not smooth and stable, but rather, is replete with noise and variation.

As explained, a robust method for gas lift optimization can effectively optimize a system of wells using a real-time data-driven approach where such a method can be model-free. A patent application having Serial No. PCT/US2022/042843, filed on 8 Sep. 2022, is incorporated by reference herein.

As an example, a problem may be stated as:

$$maxF ( X ) = {\sum }_{i = 1}^{n} {f}_{i} ( {x}_{i} ) \\ s . tG ( X ) \leq 0 \\ {x}_{i} \geq 0 ∀ i ∈ [ 1 n ]$$

Such a problem may be subject to various constraints, which may be within G(X). For example, consider resource constraints, well-level constraints and cumulative constraints, respectively:

$$Σ {x}_{i} \leq C with {L}_{i} \leq {x}_{i} \leq {U}_{i} \\ ‖ X , {X}_{o} ‖ < {d}_{max} \\ {q}_{il} \leq {B}_{li} \\ {q}_{oi} \leq {B}_{oi} \\ {q}_{wi} \leq {B}_{wi} \\ {q}_{gi} \leq {B}_{gi} \\ ρ {q}_{li} \leq {B}_{l} \\ Σ {q}_{oi} \leq {B}_{o} \\ Σ {q}_{wi} \leq {B}_{w} \\ Σ {q}_{gi} \leq {B}_{g}$$

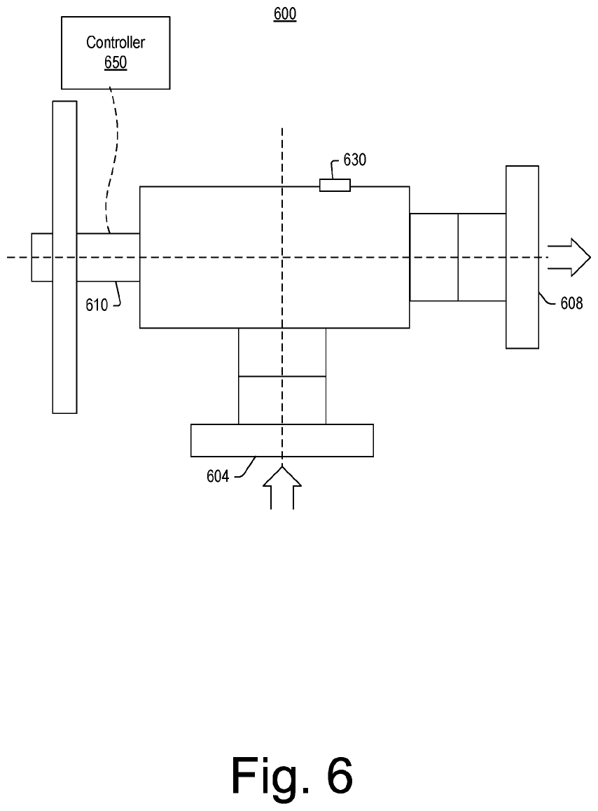

FIG. 6 shows an example of a choke valve 600. One or more choke valves can be included in a system (see, e.g., the system 200 of FIG. 2). A choke valve can be located on or near a Christmas tree that is used to control the production of fluid from a well. Opening or closing of a choke valve can influence rate and pressure at which production fluids progress through a pipeline, a process facility, etc. An adjustable choke valve (e.g., an adjustable choke) may be linked to an automated control system to enable one or more production parameters of a well to be controlled.

In the example of FIG. 6, the choke valve 600 includes openings 604 and 608 to corresponding passages where the passages 604 and 608 can be in fluid communication via adjustment of a stem 610, which may be operatively coupled to one or more types of mechanisms. For example, consider a plug and cage mechanism, a needle and seat mechanism, etc.

A plug and cage choke valve can include a plug that is operatively coupled to a stem to move the plug with respect to a cage, which may be a multi-component cage (e.g., consider an inner cage, an outer cage, etc.). In such an example, the cage can include a plurality of openings, which may be of one or more sizes. For example, consider a ring of smaller openings and a ring of larger openings where the different size openings may provide for finer adjustments to flow. In such an example, the plug may first provide for opening of the smaller openings to provide for fluid communication between passages and then, upon further axial translation, provide for opening of the larger openings to provide for more cross-sectional flow area for fluid communication between the passages. As an example, a stem of a plug and cage choke valve can be rotatable where rotation causes axial translation to position the plug with respect to the cage.

A needle and seat choke valve can include a needle portion that can be part of a stem or otherwise operatively coupled to a stem where the stem can be threaded such that rotation causes translation of the needle portion with respect to the seat. When the needle portion is initially translated an axial distance, an annulus is created that causes passages to be in fluid communication. Upon further translation, the needle portion may be completely removed from a bore of the seat such that the annular opening becomes a cylindrical opening, which provides for greater cross-sectional flow area for fluid communication between the passages.

As an example, a choke valve may include one or more sensors that can provide for one or more measurements such as, for example, one or more of position (e.g., stem, needle portion, plug, etc.), flow, pressure, temperature, etc.

As an example, a choke valve may be a unidirectional valve that is intended to be operated with flow in a predefined direction (e.g., from a high-pressure side to a lower pressure side).

A choke valve may be selected such that fluctuations in line pressure downstream of the choke valve have minimal effect on production rate. In operation, flow through a choke valve may be at so-called critical flow conditions. Under critical flow conditions, the flow rate is a function of upstream pressure or tubing pressure. For example, consider a criterion where downstream pressure is to be approximately 0.55 or less of tubing pressure.

As an example, a multiphase choke equation may be utilized to estimate the flowing wellhead pressure for a given set of well conditions along with suitable multiphase choke coefficients (e.g., Gilbert, Ros, Baxendell, Achong, etc.), which may include a number of coefficients (e.g., A₁, A₂ and A₃). For example, consider the following equation with parameter values inserted, as explained below.

$${p}_{wh} = ( 3.86 \times {10}^{- 3} ( 400 ) {( 800 )}^{0.546} ) / ( {( 12 / 64 )}^{1.89} ) = 1 , 405 psia$$

In the foregoing equation, which may be used to estimate flow rate or choke diameter, the well is producing 400 STB/D of oil with a gas-liquid ratio of 800 Scf/STB where the choke size is 12/64 inch and the Gilbert coefficients are 3.86×10⁻³, 0.546 and 1.89, respectively. As indicated, the estimated flowing wellhead pressure is 1,405 psia. In an example using the Ros choke equation, an estimated flowing wellhead pressure of 1,371 psia is calculated.

Parameters that can be utilized in various computations include discharge coefficient (Cd), pipe diameter (d), pipe length (L), specific heat capacity ratio (k) (e.g., Cp/Cv), standard pressure (psc), wellhead pressure (pwh), gas flow rate (qg), liquid flow rate (ql), standard temperature (Tsc), wellhead temperature (Twh), ratio of downstream pressure to upstream pressure (y), gas compressibility factor (z), gas specific gravity (yg), etc.

In the example of FIG. 6, the choke valve 600 includes a port 630 that may be utilized for monitoring pressure. As shown in FIG. 6, a controller 650 may be utilized to control the stem 610. For example, consider a motor that can be operatively coupled to the stem 610 such that the motor can be controlled to adjust the stem 610 (e.g., to adjust the shape and size of the opening or openings between the passages 604 and 608, etc.).

As an example, a system can utilize one or more choke formulas. For example, consider a semi-analytical approach as may be utilized for oil and gas well rate estimation. See an article by Kargarpour, Oil and gas well rate estimation by choke formula: semi-analytical approach, Journal of Petroleum Exploration and Production Technology (2019) 9:2375-2386.

In various instances, a lack of continuous well production rate measurements can lead to untimely (e.g., late) detection of production deferment. Further, various workflows may not be amenable to automation without real time production rates. Production rates can be useful for various purposes such as, for example, gas injection, water injection, chemical injection, etc.

As an example, a method may utilize an equation that can be semi-empirical and data driven to provide flow rates based on real time pressure measurements. Such an equation may be referred to as a model, however, it may lack a physical basis in that it relies on one or more parameters where values thereof are calibrated and may be re-calibrated.

As an example, an equation can be part of a virtual flow meter (VFM) that may be adaptable to a particular piece of equipment such as a flow device. A flow device may be a device that can act to control fluid flow. For example, consider a choke valve. As an example, a choke VFM may provide for estimating flow rate through a choke region of a flow device using an upstream pressure measurement and a downstream pressure measurement. Such a VFM may include two real time inputs (pressure) and one or more other inputs that may be available less frequently (e.g., flow device characteristic dimension, parameter values, etc.).

As an example, a VFM may be automatically re-calibrated. For example, an autonomous process can provide for automated re-calibrations for changing conditions. As an example, a VFM may calculate real time single and/or multiphase liquid flow rate (e.g., in a liquid agnostic manner, etc.). As an example, a VFM may provide for calculation of oil production phases using measured water cut (WC). As an example, a VFM may provide for detection of a production loss earlier than without the VFM. For example, consider detection of one or more abnormalities in oil production, gas injection, water injection, chemical injection, etc. As an example, a VFM may be deployable locally and/or remotely (e.g., cloud and/or edge, etc.). As an example, a VFM or VFMs may provide output to one or more frameworks. For example, consider a framework or frameworks that may be available within the DELFI environment.

As an example, a system can include one or more multiphase flow meters, which may be installed permanently and/or on an as-desired basis. As an example, a multiphase flow meter can include one or more features of the Vx SPECTRA surface multiphase flow meter (Schlumberger Limited, Houston, Texas). Such a flowmeter can utilize a spectrum analysis to accurately measure oil, gas, and water flow rates without phase separation. A multiphase flow meter can be utilized to measure various pressures, though it can introduce a pressure drop into a system. Such a flow meter tends to be costly and demanding of attention, in addition to introducing a pressure drop. As such, a single flow meter may be transported from location to location to acquire various multiphase flow meter measurements.

As an example, a system can include a virtual flow meter framework, which may provide for flow estimations without using a physical flow meter. As an example, a virtual flow meter can be a choke virtual flow meter (VFM) that can facilitate gas lift optimization, optionally in an automated manner.

As an example, a VFM can be a choke VFM that may, for example, be utilized for one or more purposes. As an example, one or more instances of choke VFMs may be utilized in gas lift operations, for example, to optimize gas lift. In such an example, an autonomous gas lift optimization system may be implemented that can provide for optimizing injection of lift gas and increasing production from one or more wells.

As an example, a VFM may be utilized for one or more types of equipment where a restriction may be present such as an adjustable restriction. For example, a valve can include an adjustable restriction that can regulate flow. Such a valve may be a water valve, an oil valve, a valve for a composition, etc. As an example, a water valve may be involved in one or more water related operations such as, for example, water flooding. In various examples, a VFM may be utilized in place of or in addition to a physical flow meter. As an example, a VFM may be a back-up for a physical flow meter, a physical flow meter may provide for calibrating a VFM or VFMs, etc.

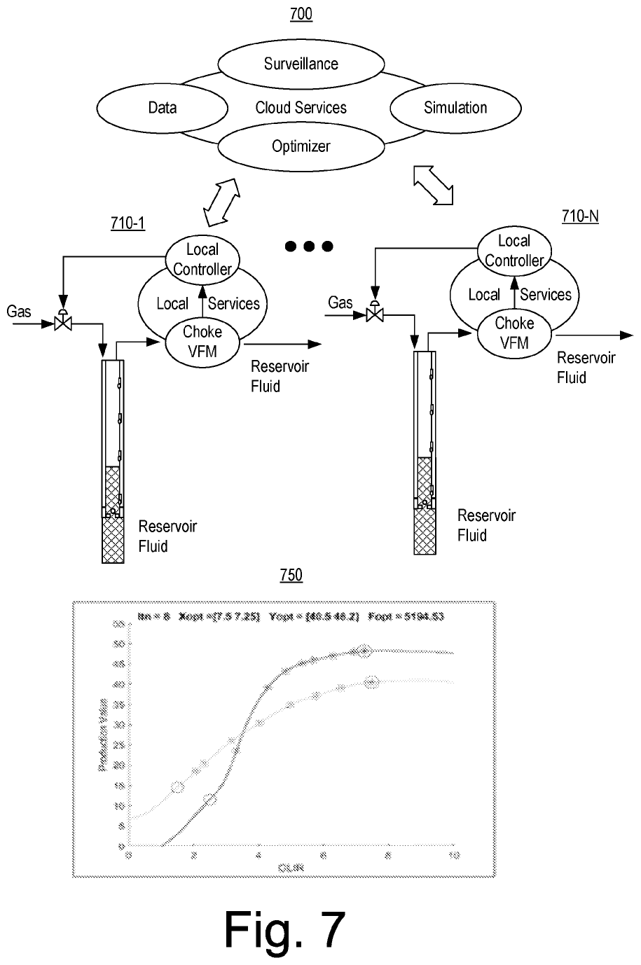

FIG. 7 shows an example of a system 700 with a series of wells 710-1 to 710-N that can be subjected to gas lift, for example, to promote production of reservoir fluid. In such an example, the system 700 may provide for production optimization, for example, via appropriate control of one or more gas lift and/or production parameters.

In the example of FIG. 7, cloud services may be utilized for performing various tasks where the cloud services can be in communication with local services at the wellsites of the wells. As an example, various features may be local and/or remote. For example, some features illustrated with respect to the cloud service may be provided locally, where resources, techniques, technologies, etc., are available.

As an example, the system 700 can provide for various types of simulation such as, for example, reservoir simulation, wellbore simulation, surface network simulation, integrated simulation, etc. As an example, the wellsites can include sensors that can acquire measurements where such measurements may be utilized locally and/or remotely. For example, consider measurements that can be obtained for derived flow rate, proxy models, simulation models, etc.

As an example, the system 700 can provide for automated continuous gas lift optimization subject to constraints. For example, consider a system where one or more cloud-enabled applications can utilize real-time flow meter information to construct well lift models, perform field-wide optimal lift gas allocation (e.g., honoring resource(s) and capacity constraints, provide cloud-hosted service(s) for local well-site control, etc.

As an example, the system 700 can include and/or utilize features of one or more cloud platforms (e.g., GOOGLE CLOUD, AMAZON WEB SERVICES CLOUD, AZURE CLOUD, etc.). As an example, the DELFI cognitive exploration and production (E & P) environment may be implemented at least in part in a cloud platform that includes one or more features of the system 700.

Choke valves (e.g., chokes) can be present in various field installations such as, for example, at wellsites to control a well. Where a downhole pump is present such as, for example, an electric submersible pump (ESP), the pump may provide features for flow control such that a choke valve is not necessary for flow control.

As explained, a choke valve can be defined via a flow parameter such as cross-sectional area of a constriction region (e.g., a “choke”), which may be represented by a diameter (e.g., an actual diameter or an effective diameter). In a choke valve, flow is expected to pass through the choke such that a choke valve can control production of fluid.

As an example, the following equation may be utilized for flow:

$$Q = a * \frac{P {1}^{b} * {( P 1 - P 2 )}^{c} * {d}^{2}}{{GLR}^{e}}$$

In the forgoing equation, P1 and P2 can be real time pressure measurement values, d is a diameter of a choke, and GLR is a gas to liquid ratio (e.g., an oil ratio if the water cut (WC) is zero). The various parameters a, b, c and e can be determined and set, which may characterize behavior of a choke. For example, a change to one or more of the parameters can provide a signature for a particular choke.

The foregoing equation provides for estimating flow (e.g., flow rate) through a choke valve, which can provide for optimization of injection and for increasing production from a well. As an example, an equation such as the foregoing equation may be utilized in a simulation. For example, consider receiving trending data (e.g., real time data) and outputting flow rates. In such an example, as time progresses, the output can reflect (e.g., simulate) the performance of a physical flow meter (e.g., a Vx flow meter, etc.).

As an example, a system can provide for automating a real time process for determining one or more relationships between injection and production for gas lift operations (e.g., gas lift as an artificial lift technology, etc.). As an example, an iterative approach may be utilized in real time to automate finding a relationship between injection and production.

As an example, a system can operate without input (e.g., ongoing input, full-time presence of, etc.) from a physical flow meter (e.g., a Vx flow meter, etc.). Such a system can help to reduce various costs, losses, etc., as may be associated with operation of a physical flow meter.

As an example, a field site can include pressure gauges. For example, consider pressure gauges that can provide pressure measurements P1 and P2. In such an example, the pressure gauges can be electronic and provide for output of signals indicative of measured pressures. For example, consider a digital pressure gauge and/or an analog and digital pressure gauge (e.g., including an analog to digital converter). As an example, field equipment may include a network device such as, for example, a gateway that can receive signals from various pieces of equipment, which may include one or more pressure gauges. As an example, a field site can include pressure gauges that can acquire pressure measurements in real time such that real time data are available (e.g., real time edge data, etc.).

As an example, a VFM may be implemented as a set of instructions that can operate in the field at a field device. For example, consider an edge application that is a choke VFM that can operate on input such as, for example, pressure measurements (e.g., P1 and P2) from two pressure gauges. Such pressure measurements can be live to provide trending data to an edge framework and/or a cloud framework where a rate may be output (e.g., a flow rate, etc.). Such output may be utilized in the field, whether generated in the field and/or generated remotely and transmitted to the field, which may be in the form of a control action, etc. While various examples refer to artificial lift (e.g., gas lift via gas injection), a VFM may be utilized for one or more purposes (e.g., water injection, chemical injection, etc.).

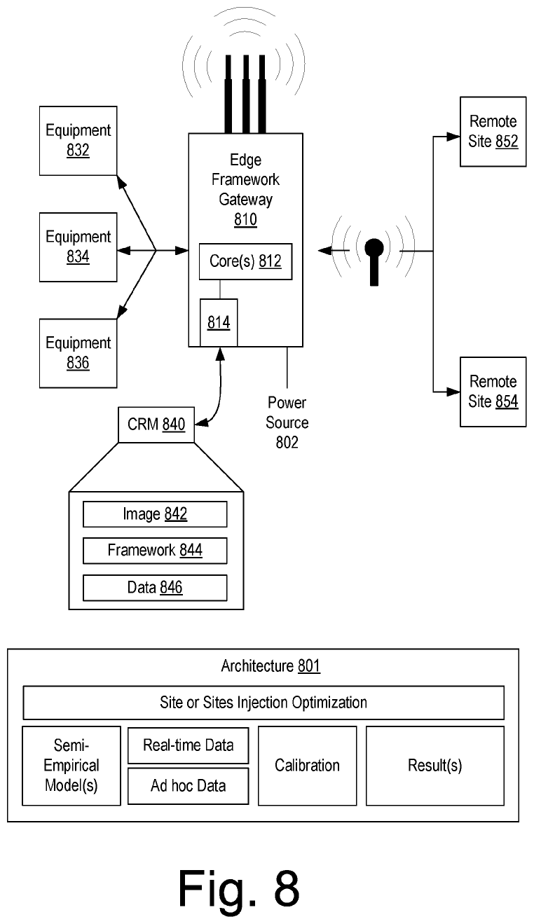

FIG. 8 shows an example of a system 800 and an example of an architecture 801. As shown, the architecture 801 can provide for site or sites injection optimization, which can be via one or more VFMs (e.g., choke VFMs, etc.). For example, the architecture 801 can generate one or more results (e.g., control actions, etc.) that can be utilized for controlling injection operation at one or more sites. In such an example, the result or results may be generated locally and/or remotely (e.g., depending on number of sites, resources, etc.). As shown, the architecture 801 can include one or more semi-empirical models. As explained, such a model can include a driving force term or terms. An example of a driving force can be a pressure differential as may be represented by two pressure measurements (e.g., P1 and P2). The architecture 801 may include one or more physics models, one or more machine learning models, etc. As shown, the architecture 801 includes an interface for real time data, optionally an interface for ad hoc data, and a calibration component. The result(s) component may include a result interface where an output result can be a control trigger, a control instruction, etc., that can call for an action or actions by a piece or pieces of equipment.

As shown, the system 800 can include a power source 802 (e.g., solar, generator, grid, etc.) that can provide power to an edge framework gateway 810 that can include one or more computing cores 812 and one or more media interfaces 814 that can, for example, receive a computer-readable medium 840 that may include one or more data structures such as an image 842, a framework 844 and data 846. In such an example, the image 842 may be an operating system image that can cause one or more of the one or more cores 812 to establish an operating system environment that is suitable for execution of one or more applications. For example, the framework 844 may be an application suitable for execution in an established operating system in the edge framework gateway 810. As an example, the framework 844 may be suitable for performing tasks associated with the architecture 801. For example, consider tasks associated with utilization of the semi-empirical model(s), setting one or more parameters of the semi-empirical model(s) via calibration, generating one or more results based at least in part on the semi-empirical model(s), etc.

In the example of FIG. 8, the edge framework gateway 810 (“EF”) can include one or more types of interfaces suitable for receipt and/or transmission of information. For example, consider one or more wireless interfaces that may provide for local communications at a site such as to one or more pieces of local equipment 832, 834 and 836 and/or remote communications to one or more remote sites 852 and 854. As an example, the local equipment 832, 834 and 836 can include one or more pressure gauges.

As an example, the EF 810 may be installed at a site that is some distance from a city, a town, etc. In such an example, the EF 810 may be accessible via a satellite communication network.

A communications satellite is an artificial satellite that relays and amplifies radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite.

High frequency radio waves used for telecommunications links travel by line-of-sight, which may be obstructed by the curve of the Earth. Communications satellites can relay signals around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency. As shown in the example of FIG. 8, the EF 810 may be deployed where it can operate locally with one or more pieces of equipment 832, 834, 836, etc., which may be for purposes of control.

As desired, from time to time, communication may occur between the EF 810 and one or more remote sites 852, 854, etc., which may be via satellite communication where latency and costs are tolerable. As an example, the CRM 840 may be a removable drive that can be brought to a site via one or more modes of transport. For example, consider an air drop, a human via helicopter, plane or boat, etc.

As to an air drop, consider dropping an electronic device that can be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF 810. Such an approach can provide for local control where one or more humans may or may not be present at the site. As an example, an autonomous and/or human controllable vehicle at a site may help to locate an electronic device and help to download its payload to an EF such as the EF 810. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As to drones, consider a drone that includes one or more features of one or more of the following types of drones DJI Matrice 210 RTK, DJI Matrice 600 PRO, Elistair Orion Tethered Drone, Freefly ALTA 8, GT Aeronautics GT380, Skydio 2, Sensefly eBee X, Skyfront Perimeter 8, Vantage Robotics Snap, Viper Vantage and Yuneec H920 Plus Tornado. The DJI Matrice 210 RTK can have a takeoff weight of 6.2 g (include battery and max 1.2 kg payload), a maximum airspeed of 13-30 m/s (30-70 mph), a range of 500 m-1 km with standard radio/video though it may be integrated with other systems for further range from base, a flight time of 15-30 minutes (e.g., depending on battery and payload choices, etc.). As an example, a gateway may be a mobile gateway that includes one or more features of a drone and/or that can be a payload of a drone.

As an example, a system may include and/or provide access to various resources that may be part of an environment such as, for example, the DELFI environment (see, e.g., FIG. 1). For example, consider the PIPESIM framework, which may be implemented locally and/or remotely (e.g., as a full and/or as a tailored framework). As an example, the PIPESIM framework and/or other framework may be utilized for one or more purposes, which may include calibration, generation of results, etc. As an example, a framework such as the PIPESIM framework may provide for comparisons between output of a semi-empirical model or models and output of the PIPESIM framework.

As an example, an EF may include a license server, a semi-empirical model(s) component, a framework simulation engine (e.g., a PIPESIM engine, etc.) and a REST API where the REST API can receive one or more API calls, for example, as one or more model requests, calibration requests, simulation requests, etc. As an example, an EF may respond to an API call with output where such output may be provided to one or more edge applications, pieces of equipment, etc. (e.g., for individual and/or coordinated control of one or more sets of equipment, etc.).

Referring again to the architecture 801, as explained, one or more physics-based models can be deployed to an edge for implementation, for example, to operate responsive to real-time data for one or more types of equipment control. As an example, a fluid simulation framework such as the PIPESIM framework may be implemented in an edge manner. Such a fluid simulation framework can be a multiphase flow simulation framework suitable for handling multiphase flow that may occur in one or more types of oil and/or gas field operations.

As shown in FIG. 8, an EF may execute within a gateway such as, for example, an AGORA gateway (e.g., consider one or more processors, memory, etc., which may be deployed as a “box” that can be locally powered and that can communicate locally with other equipment via one or more interfaces). As an example, a gateway can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in.

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke valve, a pump, etc.).

As an example, a gateway may include hardware (e.g. circuitry) that can provide for operation of a drone. As an example, a gateway may be a drone controller and a controller for other equipment where the drone controller can position the gateway (e.g., via drone flight features, etc.) such that the gateway can control the other equipment.

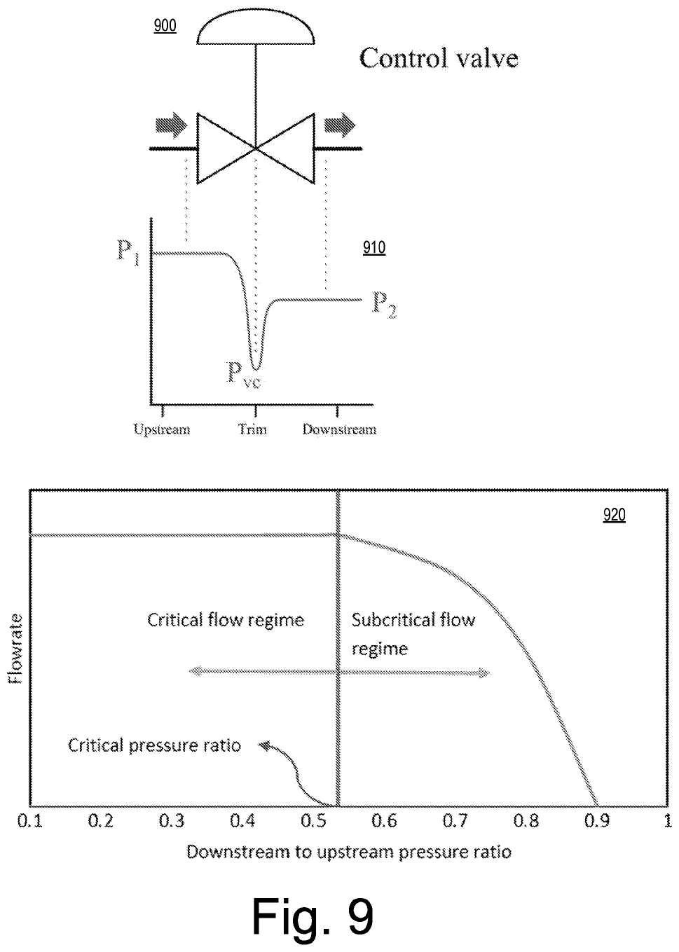

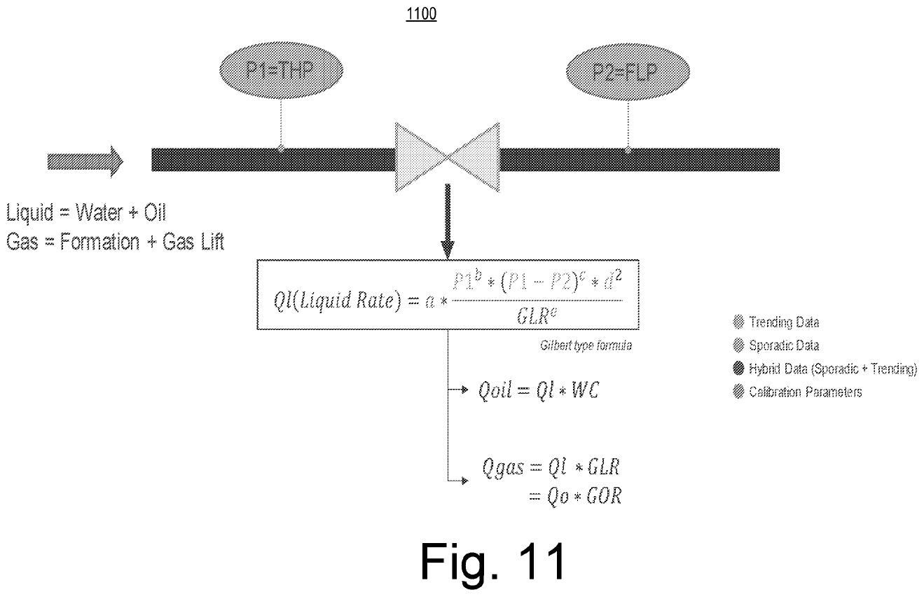

FIG. 9 shows an example of a control valve 900 and an example of a plot of pressure versus position from an upstream position to a downstream position 910 along with an example plot of flow rate versus downstream to upstream pressure ratio for two regimes, a critical flow regime and a subcritical flow regime 920. As shown in the plot 910, P1 is greater than P2 and a pressure at the valve choke (VC) is the lowest, corresponding to the trim position. In such an example, an upstream conduit and a downstream conduit may be assumed to have an approximately equal cross-sectional flow area (e.g., same diameter pipe, etc.). As explained, a valve can include a choke or constricted region that has a controllable cross-section flow area. As the area decreases, the pressure may decrease, for example, to a pressure of zero if the control valve 900 is closed. As explained, the control valve 900 can effectively control flow where such control can be characterized by an upstream pressure P1 and a downstream pressure P2. As an example, a choke valve can be adjustable, fixed, changeable, etc., as to a choke region (see, e.g., the “d” parameter in the example model of FIG. 11).

As to the plot 920, a critical pressure ratio is illustrated as having a downstream pressure to upstream pressure ratio value of approximately 0.52, which defines a critical flow regime to the left (lower ratio values) and a subcritical flow regime to the right (higher ratio values). As shown, in the critical flow regime, the flow rate is approximately constant. In other words, a change in downstream pressure to upstream pressure ratio does not result in a substantial change in flow rate. In contrast, in the subcritical flow regime, as the ratio increases, the flow rate decreases. As shown, the decrease in flow rate with respect to an increase in the ratio can be non-linear over one or more ranges of ratio values and may be approximately linear over one or more ranges of ratio values.

In the example of FIG. 9, the term “critical” can be based on a relationship between flow and pressure. As explained, P1 is to be higher than P2 for flow to occur. Where P1 is “close” to P2, operation can be in a subcritical flow regime such that a change in P2 affects the flow rate; whereas, if the difference between P1 and P2 is quite large, then changing P2 can have little effect on the flow rate. For operational scenarios, operation may be in a critical or in a subcritical flow regime. In the example model of FIG. 11, where P1-P2 is associated with the c parameter, the value of c will be higher in the subcritical flow regime and will be smaller in the critical flow regime. If in a critical flow regime, if P1 can be changed, then flow rate may be increased.

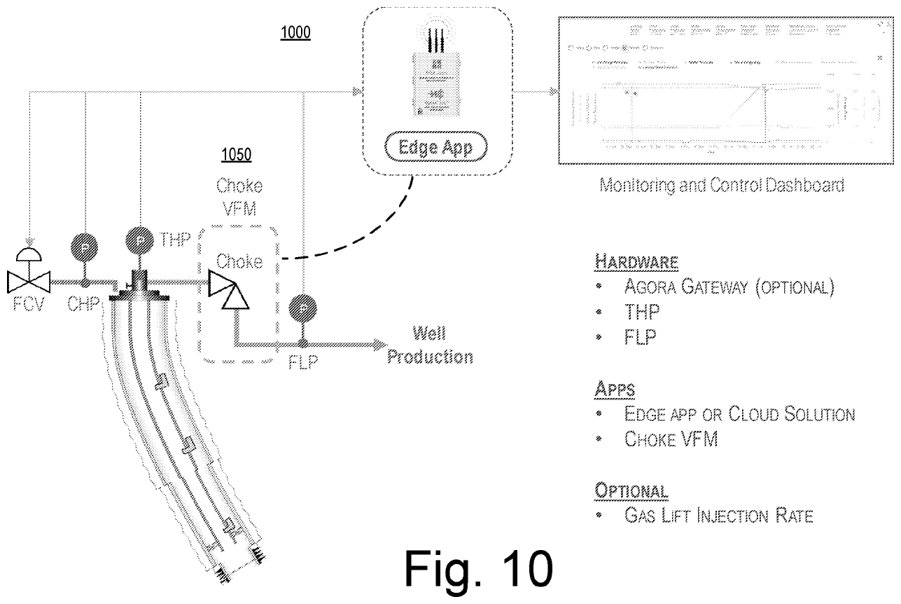

FIG. 10 shows an example of a system 1000 that includes a wellsite with a well that includes various types of equipment. As shown, the wellsite can include a flow control valve (FCV) for injection control, a pressure gauge (CHP) for injection pressure, a pressure gauge (THP) at a wellhead for upstream reservoir fluid pressure, a choke valve and a pressure gauge (FLP) for downstream reservoir fluid pressure. As shown, a choke VFM 1050 can be implemented for the choke valve where the choke VFM 1050 may be part of an edge application executing on a field device (e.g., an edge device, etc.). The choke VFM 1050 can provide for outputting a rate across the choke valve, for example, based on measurements from the upstream and downstream pressure gauges. In the example of FIG. 10, the edge application may control the flow control valve for injection, for example, to control gas lift as an artificial lift enhancement to the well. As explained, such an approach may account for injection at one or more wells. In the example of FIG. 10, a graphical user interface (GUI) is shown that can provide for monitoring and/or control at one or more wellsites.

FIG. 11 shows an example of a system 1100 that provides a schematic diagram of various equipment in the system 1000 of FIG. 10. The system 1100 shows the pressure measures P1=THP and P2=FLP where liquid can include water and oil and gas can include formation gas and lift gas. For example, produced fluid can include formation oil, formation water, formation gas and lift gas.

As shown in FIG. 11, the trending data are P1 and P2, the sporadic data are the dimension d of the valve (e.g., an adjustable valve), the hybrid data (e.g., sporadic and trending) is the gas lift ratio (GLR), and the calibration parameters are a, b, c and e. In the example of FIG. 11, a Gilbert type of formula is shown, noting that one or more other types of models (e.g., formulas) may be utilized. In the example of FIG. 11, WC is the water cut and GOR is the gas oil ratio. In the example of FIG. 11, the GLR may be optional as it can depend on whether gas lift is being utilized or not.

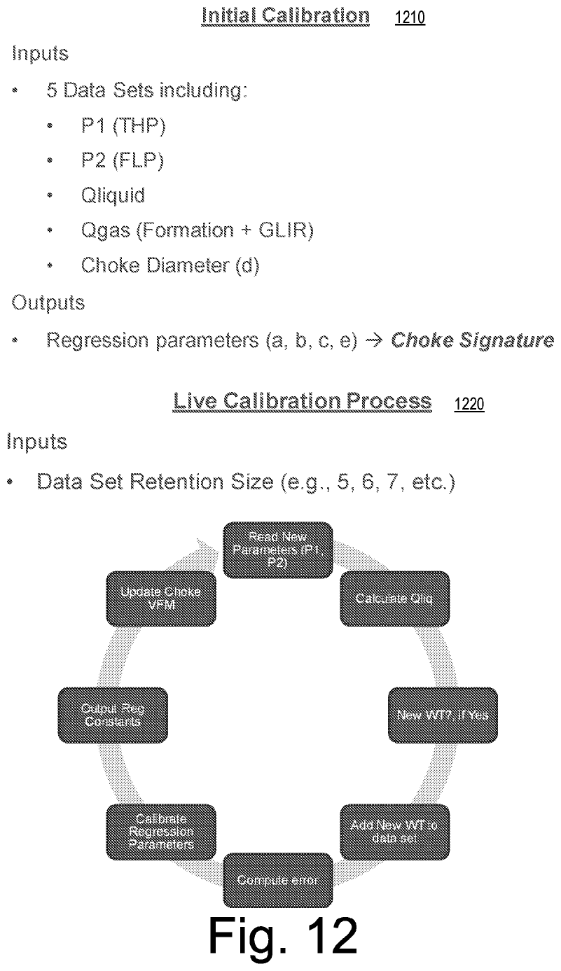

FIG. 12 shows an example of an initial calibration 1210 and an example of a live calibration 1220. As shown, the initial calibration 1210 can include five data sets: P1, P2, Q-liquid, Q-gas, and choke dimension (e.g., diameter) where output can be the parameters a, b, c and e, which can be determined using one or more techniques (e.g., regression, etc.).

As to the live calibration 1220, as shown, it can depend on performance of one or more well tests. As an example, a well test may be performed on a regulatory basis. For example, consider a well in a region where a regulatory authority demands a well test on a monthly basis. A well test can provide various types of information that can assist in calibration.

As shown, the live calibration 1220 can be a cyclical process that include reading new parameters (e.g., P1, P2), calculating a liquid flow rate (Q-liq), deciding whether a new well test (WT) is demanded (e.g., or existing), adding a new WT to a data set (e.g., 5, 6, 7, etc.), computing error (e.g., difference between computed liquid flow rate and well test measured flow rate), calibrating the parameters (e.g., via regression, etc.), outputting the constants, and updating the VFM (e.g., a choke VFM). In the example of FIG. 12, a number of well tests may be utilized for computing error, etc. For example, values from a desired number of well tests may be utilized, which may depend on frequency of well tests, flow from a well, etc. For example, if a well is changing due to one or more circumstances, live calibration may be tailored. As an example, an alarm may be issued where circumstances change in a manner such that a critical boundary is being approached. As explained with respect to the plot 910 of FIG. 9, in a critical flow regime, control as to flow may be somewhat lost as a change in pressure ratio will not provide a change in flow.

As an example, where a computed error is determined by a method, which may be part of a live calibration method, if the computed error is below a certain value a well test may be performed according to a normal schedule; whereas, if a computed error is greater than or equal to a particular value (e.g., threshold, etc.), then a change in schedule may be indicated, for example, to expedite performance of the next well test or to add an additional well test into a schedule.

As an example, a change in water cut (WC) may be utilized as an indicator for a well test. For example, where a change is greater than a threshold or less than a threshold, a well test may be called for. As an example, where P2 is 30 percent of P1, and then where P2 is 70 percent of P1, the pressure differentials can differ beyond a threshold value, which may trigger one or more actions. As an example, a threshold condition may be utilized in a manner whereby a comparison is made as to more than or less than.

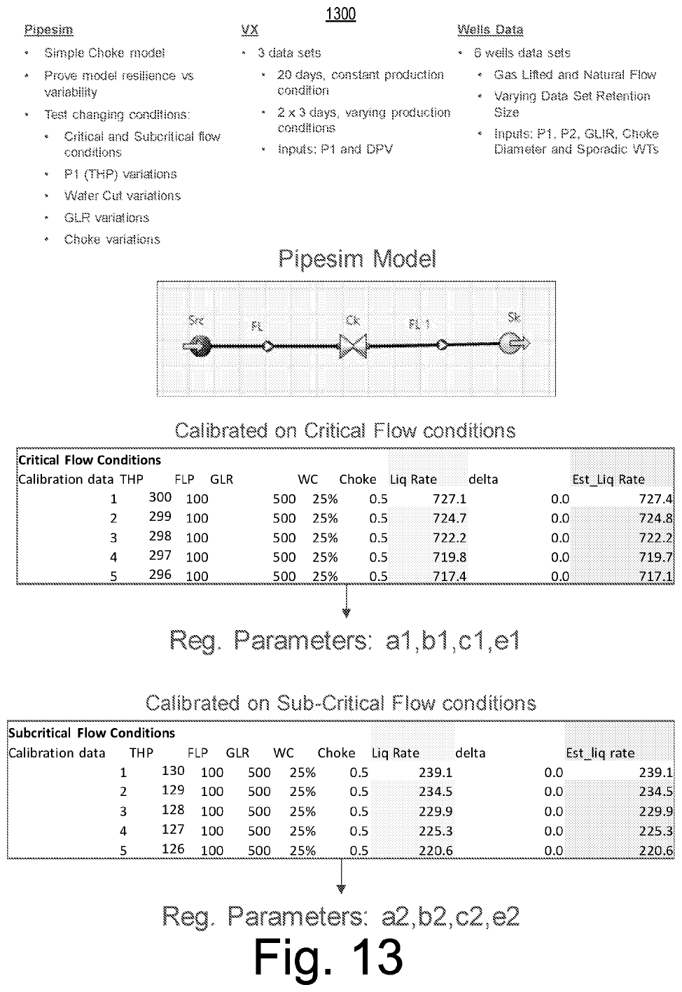

FIG. 13 shows an example of a system 1300 that can perform various calibrations including gas lift (see GLIR). In the example of FIG. 13, data include PIPESIM data, Vx (VX) data, and data from wells. In FIG. 13, tables show various values for pressures, GLR, WC, choke dimension, liquid flow rate and estimated liquid flow rate.

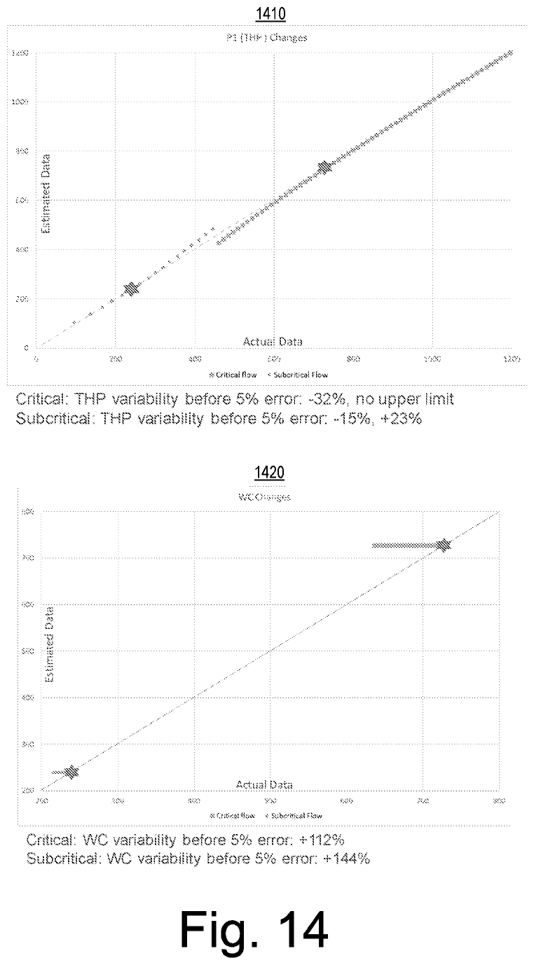

FIG. 14 shows example plots 1410 and 1420 for estimated data versus actual data. In the plots 1410 and 1420, critical and subcritical flow regimes are shown where the plot 1410 shows variability in the pressure THP and where the plot 1420 shows variability in the water cut (WC).

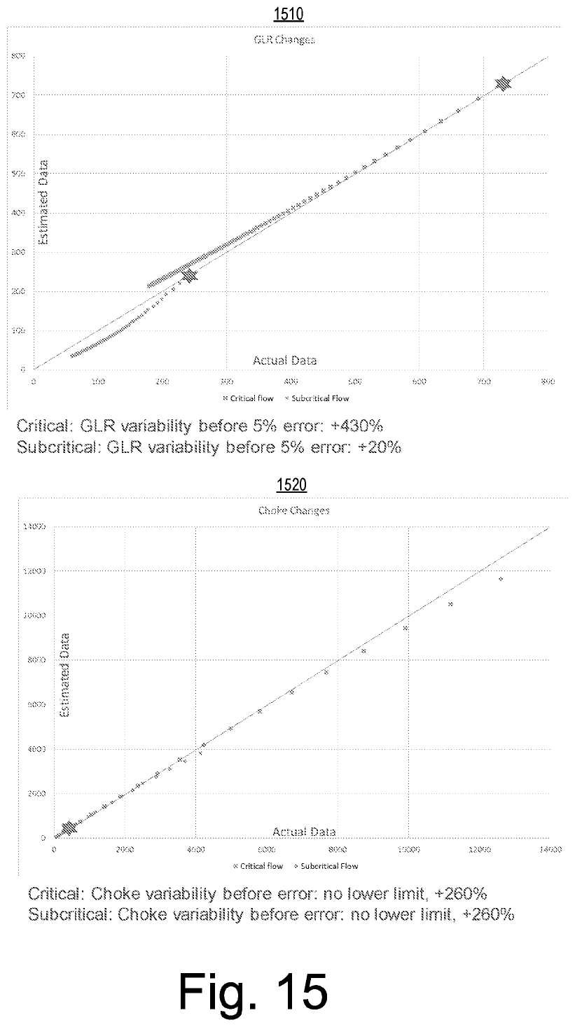

FIG. 15 shows example plots 1510 and 1520 for estimated data versus actual data. In the plots 1510 and 1520, critical and subcritical flow regimes are shown where the plot 1510 shows variability in the gas liquid ratio (GLR) and where the plot 1520 shows variability in the choke dimension.

As an example, a system may be tailored for a type of well. For example, a well with many changes can utilize lesser points with acceptable noise; however, a well with stability, high water cut, etc., may utilize more points with lesser noise.

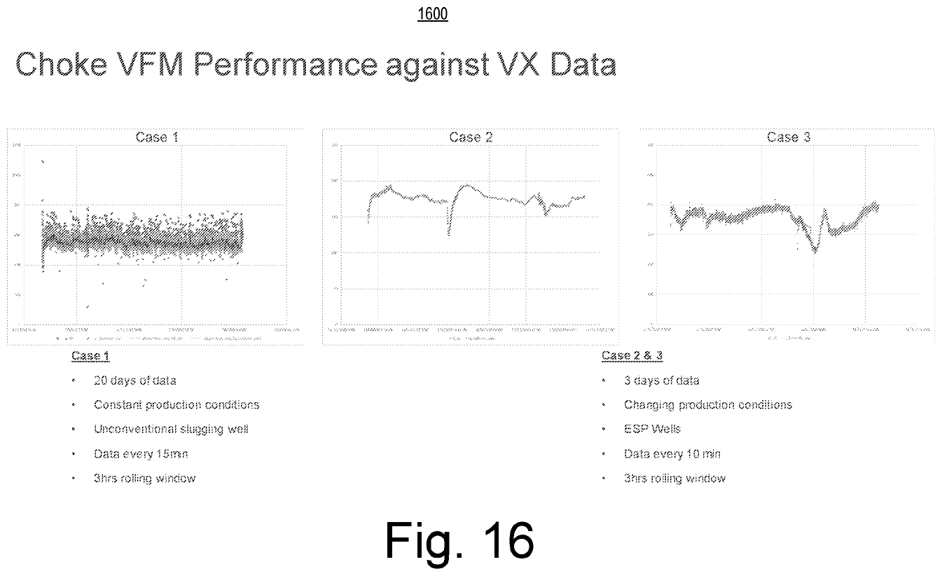

FIG. 16 shows an example of choke VFM performance with respect to Vx flow meter data 1600 for three cases. In a first case, 20 days of data are utilized under relatively constant production conditions in an unconventional slugging well with data acquired at 15-minute intervals with a 3-hour rolling window. For second and third cases, three days of data are acquired with changing production conditions in ESP wells with data at 10-minute intervals with a 3-hour rolling window.

As shown in FIG. 16, the choke VFM performs adequately with particular acceptable performance in cases 2 and 3 for the three days of data with changing production conditions.

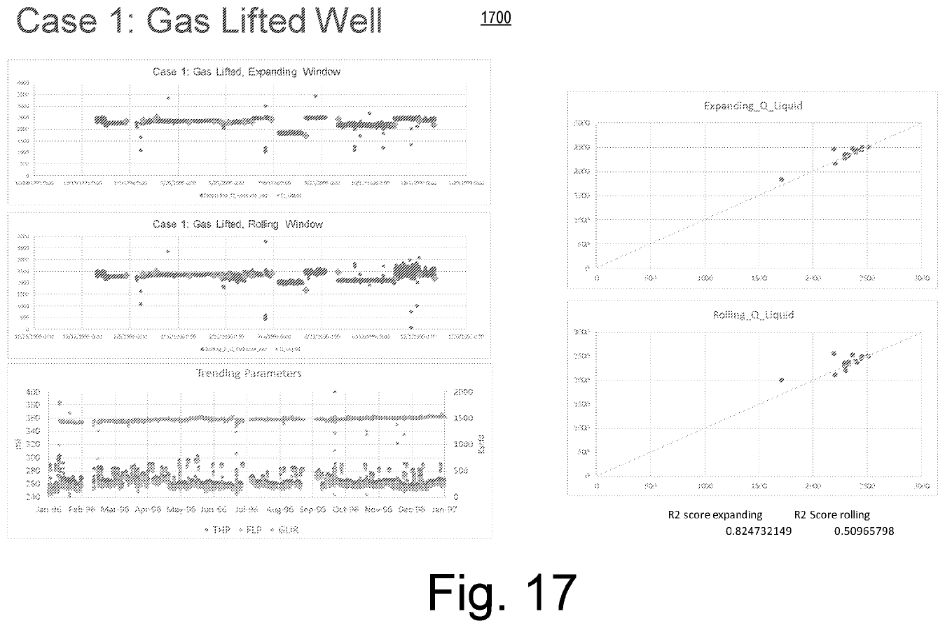

FIG. 17 shows a series of example plots 1700 for a scenario for gas lifted wells. The plots 1700 include plots of flow rate in bbl/day versus time using an expanding window and a rolling window, a plot of trending parameters for pressure in psi and gas lift injection rate (GLIR), and plots of estimated values versus measured values. As shown, one or more types of windows may be utilized for computing liquid flow rate where such values may be compared to measured values, for example, where data from a well test, installation of a Vx flow meter, etc., are available.

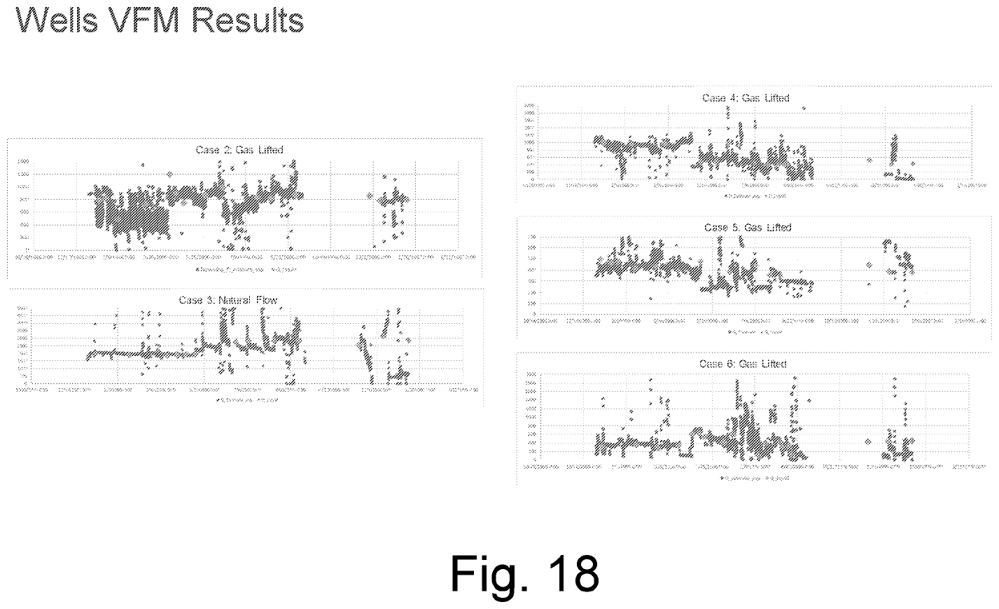

FIG. 18 shows a series of example plots 1800 for a scenario for gas lifted wells with comparisons between computed flow rates (e.g., via a VFM) and Vx flow meter measured flow rates. The plots 1800 include one plot for natural flow without gas lift and four plots for gas lift.

As explained, a system may utilize local and/or remote features. For example, a VFM may be calibrated initially using cloud-based resources (e.g., a cloud platform, DELFI environment, etc.) and then distributed to one or more local devices (e.g., one or more edge devices). In such an example, further calibrations may occur locally and/or remotely. For example, well test data may be available for local calibration and/or well test data may be transmitted to the cloud where a calibration may be performed remotely followed by transmission of one or more models or values (e.g., parameter values) to a local device. As an example, an initial calibration may be more general than a subsequent calibration. For example, subsequent calibrations can utilize data acquired at a site that is representative of conditions at the site whereas an initial calibration may utilize offset well data, laboratory data, etc.

As an example, a method can include generating calibrated models in the cloud and then utilizing a staging area for deployment to the field. For example, consider a cloud service operated by a first entity and field equipment operated by a second entity. In such an example, the first entity may not have access to the field equipment such that the second entity is to perform the deployment of the calibrated models from the staging area to the field equipment. In such an example, once in the field, calibrations may be handled using a manner selected by the second entity (e.g., local calibrations, transmission of data for use in recalibration to the first entity, etc.). As an example, a method can include local initial calibration and local subsequent calibration.

As an example, a “smart” valve may include one or more pressure measurement interfaces and/or one or more pressure gauges. In such an example, the smart valve may include processing and memory resources sufficient for using a model and/or calibrating a model where the model can output flow rates based on pressure measurements. As mentioned, a field device may generate an alarm for recalibration of a VFM, which may include calling for performing a well test. As mentioned, a smart flow meter may include a VFM that can be utilized where, for example, one or more features of the smart flow meter may be shut down, not operational, fouled, etc.

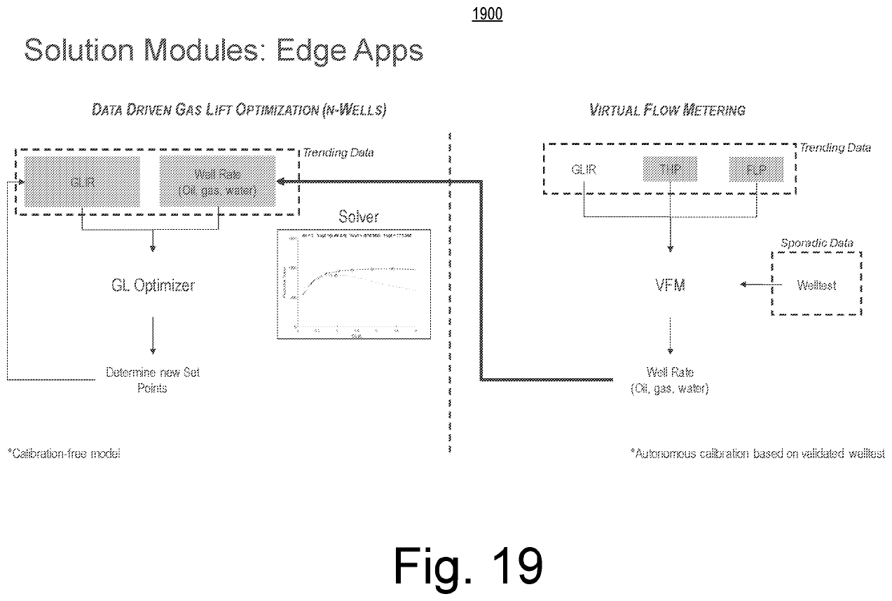

FIG. 19 shows an example of a system 1900 that includes a VFM component and a data driven gas lift optimization component. As shown, the VFM can output flow rates that can be utilized in the data driven gas lift optimization component.

As explained, one or more VFMs may be utilized for one or more purposes. For example, consider leak detection where multiple VFMs may be utilized and where estimates may be compared. In such an approach, leak detection may be more robust without demand for installation of physical flow meters of one or more additional physical flow meters.

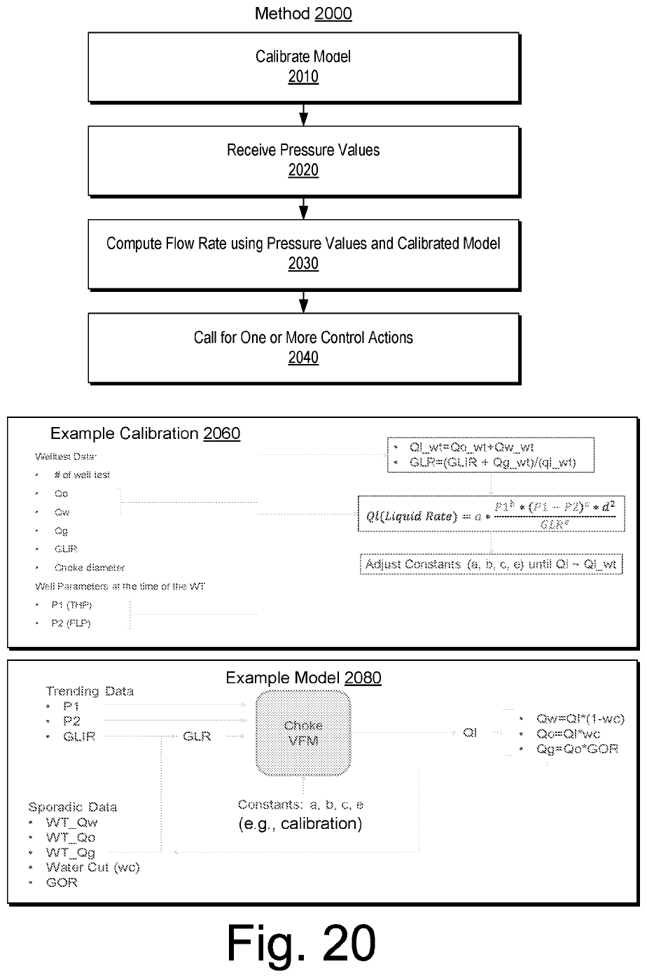

FIG. 20 shows an example of a method 2000 that can include a calibration block 2010 for calibrating a model using pressure and flow rate data to generate a calibrated model; a reception block 2020 for receiving an upstream pressure value and a downstream pressure value that define a pressure differential across a flow device; and a computation block 2030 for computing a flow rate through the flow device using the upstream pressure value, the downstream pressure value and the calibrated model. As shown, the method 2000 may include a call block 2040 for calling for one or more control actions based at least in part on a computed flow rate.

FIG. 20 also shows an example of a calibration 2060 and an example of a model 2080. As shown, the example calibration 2060 can utilize well test data, for example, from a number of well tests, which can provide various types of data (e.g., flow rates, GLIR, choke dimension, etc.), including various well parameters at the time of the well test (e.g., P1 (THP) and P2 (FLP), etc.). As shown, an iterative process may be utilized for calibration, for example, by adjusting one or more of the parameters a, b, c and e until a condition is met (e.g., output of the model is suitably close to actual measured value(s)). As shown, the example model 2080 can utilize the adjusted parameters a, b, c and e for implementation of a virtual flow meter (VFM). In FIG. 20, the example model 2080 can receive various types of data such as trending data (e.g., P1, P2, GLIR, etc.), sporadic data (e.g., well test data) where a gas liquid ratio (GLR) may be determined using a combination of trending and sporadic data. As shown, output may be a liquid flow rate (e.g., a liquid flow rate virtual flow meter), where the liquid flow rate may be utilized to compute one or more other flow rates (e.g., Qw, Qo and Qg), as appropriate.

As mentioned, a model may be utilized in a simulation. For example, consider receiving trending data (e.g., real time data) and outputting flow rates with respect to time (e.g., in real time). In such an example, as time progresses, the output can reflect (e.g., simulate) performance of a physical flow meter (e.g., a Vx flow meter, etc.). As an example, a graphical user interface (GUI) may include a numeric graphic, a needle graphic, etc. As an example, a GUI may include a gauge such as a round gauge with a needle, a digital gauge with a numeric output, a colorized gauge with a spectrum of flow rates from low to high, etc.).

As an example, a calibration process may utilize one or more data processing techniques. For example, consider utilizing windows for data, statistical process of data, introduction of noise, etc. As an example, a graphical user interface (GUI) may provide for visualization of a calibration process, for example, consider plotting actual values of flow and model output values of flow with respect to time such that a user may visualize how a model is performing during calibration. As an example, once calibrated, a GUI may present a replay where the model output can be viewed with respect to actual values to determine how accurately the model output matches the actual values, for example, as one or more of the inputs may change (e.g., P1, P2, etc.).

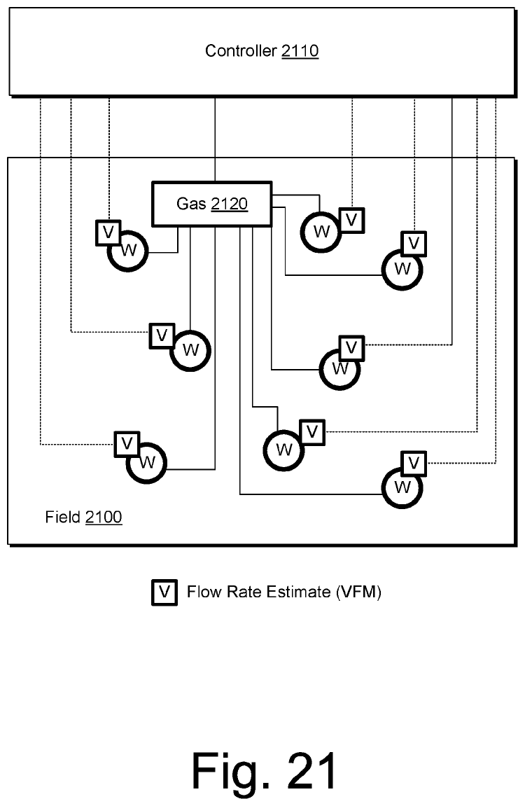

FIG. 21 shows an example of a controller 2110 with respect to a field 2100 that includes wells (W), VFMs (V) and a supply of gas 2120. As shown, the controller 2110 can issue instructions to the field 2100 such that gas from the gas supply 2120 may be controlled at a manifold and/or locally (e.g., well-by-well, etc.). As an example, a wired and/or a wireless network may be utilized for control and/or receipt of output from the VFMs (V).

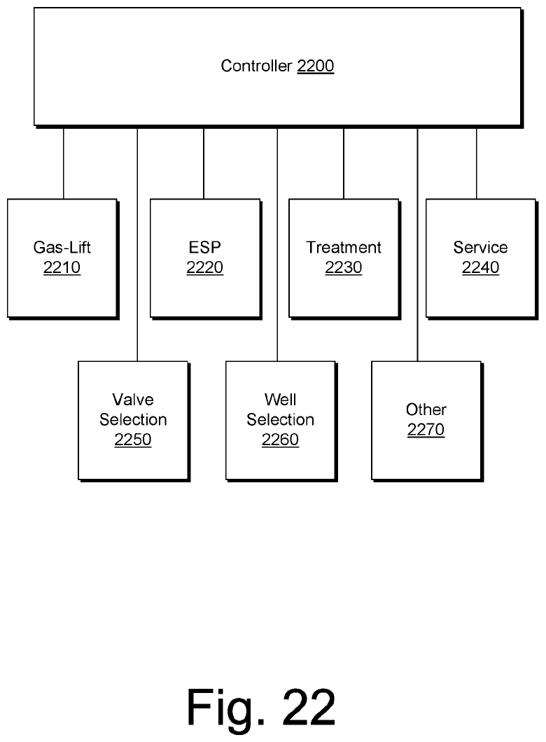

FIG. 22 shows an example of a controller 2200, which may be implemented as the controller 2110 of FIG. 21. In the example of FIG. 22, the controller 2200 can include one or more components such as, for example, one or more of a gas lift component 2210, an electric submersible pump component 2220, a treatment component 2230, a service component 2240, a valve selection component 2250, a well selection component 2260 and one or more other components 2270. As explained, information gleaned via control such as according to the method 2000 may be utilized to determine one or more actions that may aim to improve production, improve operation of equipment (e.g., valves, etc.), improve utilization of one or more resources (e.g., gas, electricity for an ESP, chemical injection, etc.).

As an example, a method can include analyzing a result for an indication of an issue. For example, consider one or more of a production issue, a valve issue, a gas supply issue, a scaling issue and an energy issue. In such an example, a result may be compared to one or more other wells and/or past results. As an example, a trained machine learning model may be utilized to detect one or more issues. For example, consider a labeled set of regression results, which may be actual, simulated, actual and simulated, etc., that can be utilized to train a machine learning model (e.g., a neural network, etc.). Once trained, a method can include analyzing a regression-based result using the trained machine learning model to detect or predict a likelihood of an issue or issues. As mentioned, an issue may be a scaling issue where scaling of a valve can be mitigated via servicing, chemical treatment, etc. As an example, measurements may be analyzed, for example, with respect to noise or types of noise. For example, scaling or other issues may present certain behavior or noise in measurement data (e.g., sensor data). As an example, a machine learning approach may be utilized to detect one or more issues using one or more types of input.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model, may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange to various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUS)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a method can include calibrating a model using pressure and flow rate data to generate a calibrated model; receiving an upstream pressure value and a downstream pressure value that define a pressure differential across a flow device; and computing a flow rate through the flow device using the upstream pressure value, the downstream pressure value and the calibrated model. As an example, such a method can be part of a real time simulation where pressure data are received and flow rate output where the model simulates a physical flow meter (e.g., Vx meter, etc.).

As an example, a flow rate can be a liquid flow rate. For example, consider a mass flow rate, a volumetric flow rate, etc. As an example, an upstream pressure value and a downstream pressure value can correspond to multiphase flow of liquid and gas phases.

As an example, a method can include computing that includes raising an upstream pressure value to a first exponent to determine a first term, raising a pressure differential to a second exponent to determine a second term, and multiplying the first term, the second term and a square of a characteristic dimension of a flow device (e.g., a choke valve, etc.). In such an example, a method can include calibrating that determines the first exponent and the second exponent.

As an example, a model can be a semi-empirical model that includes a pressure differential as a driving force. As an example, a model can account for a critical flow regime and a subcritical flow regime. For example, consider a critical pressure ratio value of downstream pressure to upstream pressure that defines a boundary between the critical flow regime and the subcritical flow regime. As an example, a model can be a simulation model that may operate based at least in part on trending data (e.g., streaming data, etc.), which may be real time or near real time where the simulation model can provide output in real time or near real time. Such a model can provide for indications of one or more issues in a timely manner, which may provide for early control, production optimization, etc.

As an example, a flow device can be a choke valve. For example, consider a choke valve that is in fluid communication with a well to receive well fluid. In such an example, the well fluid may be reservoir fluid that may include one or more injected materials. For example, consider gas as an injected material (e.g., gas lift for artificial lift, etc.).

As an example, a method can include, based at least in part on a virtual meter flow rate, controlling injection of material into a well. In such an example, the material can include one or more of gas, water, a treatment chemical or another material or materials.

As an example, a method can include comparing a flow rate (e.g., a VFM flow rate) to a historical flow rate. In such an example, a historical flow rate can be based on data from at least one well test. As an example, a method can include deciding to re-calibrate a model based at least in part on a comparison (e.g., a model-based flow rate to an actual flow rate, which may be present time, historical, etc.). As an example, a method can include deciding to perform a well test based at least in part on a comparison (e.g., a model-based flow rate to an actual flow rate, which may be present time, historical, etc.).

As an example, a method can include calibrating that is performed locally at a site of a flow device and/or calibrating that is performed remote from a site of a flow device. As an example, a method can include computing that is performed locally at a site of a flow device.

As an example, a system can include a controller that outputs a signal for adjustment of a valve upstream a flow device; a pressure measurement interface that receives an upstream pressure value from a pressure gauge upstream the flow device and a downstream pressure value from a pressure gauge downstream the flow device; and a calibrated model that computes liquid flow rate through the flow device based on the upstream pressure value and the downstream pressure value, where the controller outputs the signal based at least in part on the liquid flow rate. In such an example, the system can include a calibrator that generates the calibrated model. As an example, a controller may be operatively coupled to a valve via a local communication network. As an example, a calibrated model can be embedded in a controller and/or a flow device where, for example, a flow device can include an integral or embedded controller.

As an example, a controller can include a pressure measurement interface. For example, consider a pressure measurement interface that can receive pressure measurements from one or more gauges.

As an example, a flow device can be a choke valve. As an example, a valve can be a gas injection valve in fluid communication with an annulus of a well. For example, consider an operation that injects gas into an annulus of a well where the well is fit with one or more gas lift injection valves.

As an example, a valve may be a water injection valve and/or a treatment chemical injection valve.

As an example, a system can include one or more processors; memory accessible to at least one of the one or more processors; processor-executable instructions stored in the memory and executable to instruct the system to: calibrate a model using pressure and flow rate data to generate a calibrated model; receive an upstream pressure value and a downstream pressure value that define a pressure differential across a flow device; and compute a flow rate through the flow device using the upstream pressure value, the downstream pressure value and the calibrated model.

As an example, one or more computer-readable storage media can include processor-executable instructions to instruct a computing system to: calibrate a model using pressure and flow rate data to generate a calibrated model; receive an upstream pressure value and a downstream pressure value that define a pressure differential across a flow device; and compute a flow rate through the flow device using the upstream pressure value, the downstream pressure value and the calibrated model.

As an example, a computer program product can include one or more computer-readable storage media that can include processor-executable instructions to instruct a computing system to perform one or more methods and/or one or more portions of a method.

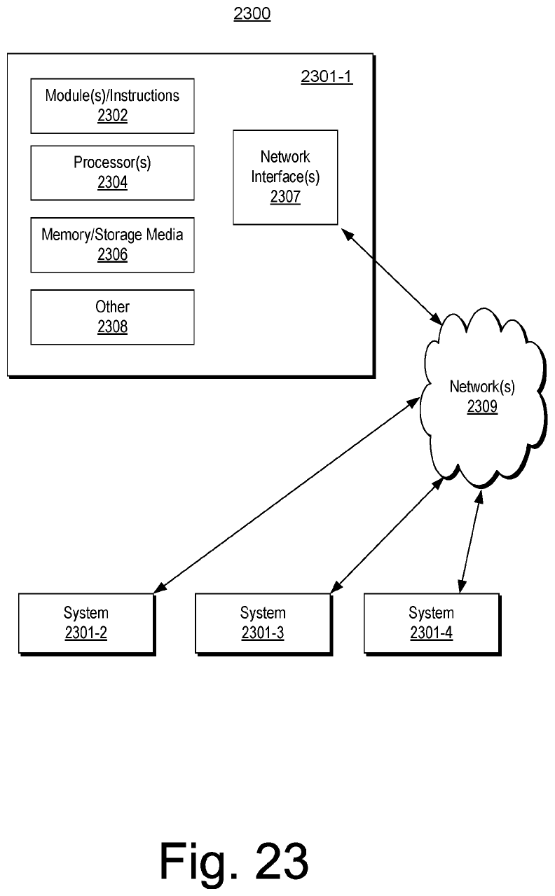

In some embodiments, a method or methods may be executed by a computing system. FIG. 23 shows an example of a system 2300 that can include one or more computing systems 2301-1, 2301-2, 2301-3 and 2301-4, which may be operatively coupled via one or more networks 2309, which may include wired and/or wireless networks.

As an example, a system can include an individual computer system or an arrangement of distributed computer systems. In the example of FIG. 23, the computer system 2301-1 can include one or more modules 2302, which may be or include processor-executable instructions, for example, executable to perform various tasks (e.g., receiving information, requesting information, processing information, simulation, outputting information, etc.).

As an example, a module may be executed independently, or in coordination with, one or more processors 2304, which is (or are) operatively coupled to one or more storage media 2306 (e.g., via wire, wirelessly, etc.). As an example, one or more of the one or more processors 2304 can be operatively coupled to at least one of the one or more network interface 2307. In such an example, the computer system 2301-1 can transmit and/or receive information, for example, via the one or more networks 2309 (e.g., consider one or more of the Internet, a private network, a cellular network, a satellite network, etc.).

As an example, the computer system 2301-1 may receive from and/or transmit information to one or more other devices, which may be or include, for example, one or more of the computer systems 2301-2, etc. A device may be located in a physical location that differs from that of the computer system 2301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 2306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include general-purpose processors or application specific chips (e.g., or chipsets), such as ASICs, FPGAs, PLDs, or other appropriate devices.

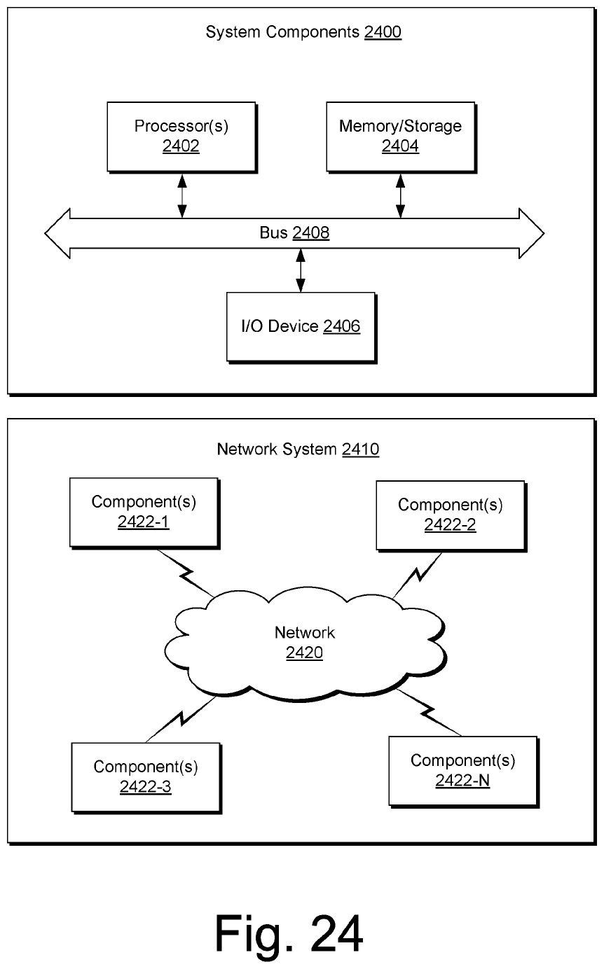

FIG. 24 shows components of an example of a computing system 2400 and an example of a networked system 2410 with a network 2420. The system 2400 includes one or more processors 2402, memory and/or storage components 2404, one or more input and/or output devices 2406 and a bus 2408. In an example embodiment, instructions may be stored in one or more computer-readable media (e.g., memory/storage components 2404). Such instructions may be read by one or more processors (e.g., the processor(s) 2402) via a communication bus (e.g., the bus 2408), which may be wired or wireless. The one or more processors may execute such instructions to implement (wholly or in part) one or more attributes (e.g., as part of a method). A user may view output from and interact with a process via an I/O device (e.g., the device 2406). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2410. The network system 2410 includes components 2422-1, 2422-2, 2422-3, . . . 2422-N. For example, the components 2422-1 may include the processor(s) 2402 while the component(s) 2422-3 may include memory accessible by the processor(s) 2402. Further, the component(s) 2422-2 may include an I/O device for display and optionally interaction with a method. The network 2420 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method comprising:
calibrating a model using pressure and flow rate data to generate a calibrated model;
receiving an upstream pressure value and a downstream pressure value that define a pressure differential across a flow device; and
computing a flow rate through the flow device using the upstream pressure value, the downstream pressure value and the calibrated model.

2. The method of claim 1, wherein the flow rate is a liquid flow rate.

3. The method of claim 1, wherein the upstream pressure value and the downstream pressure value correspond to multiphase flow of liquid and gas phases.

4. The method of claim 1, wherein the computing comprises raising the upstream pressure value to a first exponent to determine a first term, raising the pressure differential to a second exponent to determine a second term, and multiplying the first term, the second term and a square of a characteristic dimension of the flow device.

5. The method of claim 4, wherein the calibrating determines the first exponent and the second exponent.

6. The method of claim 1, wherein the model is a semi-empirical model that comprises a pressure differential as a driving force.

7. The method of claim 1, wherein the model accounts for a critical flow regime and a subcritical flow regime.

8. The method of claim 7, wherein a critical pressure ratio value of downstream pressure to upstream pressure defines a boundary between the critical flow regime and the subcritical flow regime.

9. The method of claim 1, wherein the flow device is a choke valve in fluid communication with a well to receive well fluid.

10. (canceled)

11. The method of claim 1, comprising, based at least in part on the flow rate, controlling injection of material into a well.

12. The method of claim 11, wherein the material comprises gas, water, or a treatment chemical.

13-14. (canceled)

15. The method of claim 1, comprising comparing the flow rate to a historical flow rate, wherein the historical flow rate is based on data from at least one well test.

16. (canceled)

17. The method of claim 15, comprising deciding to re-calibrate the model based at least in part on the comparing.

18. The method of claim 15, comprising deciding to perform a well test based at least in part on the comparing.

19. The method of claim 1, wherein the calibrating and the computing are performed locally at a site of the flow device.

20. The method of claim 1, wherein the calibrating is performed remote from a site of the flow device.

21. (canceled)

22. A system comprising:
a controller that outputs a signal for adjustment of a valve upstream a flow device;
a pressure measurement interface that receives an upstream pressure value from a pressure gauge upstream the flow device and a downstream pressure value from a pressure gauge downstream the flow device; and
a calibrated model that computes liquid flow rate through the flow device based on the upstream pressure value and the downstream pressure value, wherein the controller outputs the signal based at least in part on the liquid flow rate.

23. (canceled)

24. The system of claim 22, wherein the controller is operatively coupled to the valve via a local communication network.

25-27. (canceled)

28. The system of claim 22, wherein the valve is a gas injection valve in fluid communication with an annulus of a well, a water injection valve, or a treatment chemical injection valve.

29-30. (canceled)

31. A system comprising:
one or more processors;
memory accessible to at least one of the one or more processors;
processor-executable instructions stored in the memory and executable to instruct the system to:
calibrate a model using pressure and flow rate data to generate a calibrated model;
receive an upstream pressure value and a downstream pressure value that define a pressure differential across a flow device; and
compute a flow rate through the flow device using the upstream pressure value, the downstream pressure value and the calibrated model.

32. (canceled)
